(19) United States
(12) Patent Application Publication
(10) Pub. No.: US 2026/0038472 A1
(43) Pub. Date: Feb. 5, 2026

(54) SOUND INSULATOR

(71) Applicant: DENSO CORPORATION, Kariya-city (JP)

(72) Inventors: Masayoshi SATAKE, Nisshin-city (JP); Shogo NAKAMURA, Nisshin-city (JP); Sakiko UESAKA, Nisshin-city (JP); Ayaka SUZUKI, Kariya-city (JP)

(21) Appl. No.: 19/234,697

(22) Filed: Jun. 11, 2025

(30) Foreign Application Priority Data
Jul. 31, 2024 (JP) 2024-124866

(51) Int. Cl. G10K 11/175; G10K 11/16

(52) U.S. Cl. CPC G10K 11/175; G10K 11/161

(57) ABSTRACT

A sound insulator includes the space forming portion which have an introduction portion that forms a transmission space for transmitting sound waves and introduces sound waves into the transmission space and a discharge portion for guiding the sound waves introduced into the transmission space to the outside of the transmission space. The sound insulator includes a phase adjustment portion that attenuates sound waves corresponding to the frequency of the sound waves whose phases have been changed among the sound waves transmitted through the transmission space by changing the phase of some of the sound waves transmitted through the transmission space. The phase adjustment portion changes the frequency band of the sound wave whose phase is to be changed.

### CROSS REFERENCE TO RELATED APPLICATIONS

The present application is based on Japanese Patent Application No. 2024-124866 filed on Jul. 31, 2024, the description of which is incorporated herein by reference.

### TECHNICAL FIELD

The present disclosure relates to a sound insulator.

### BACKGROUND

Conventionally, there has been known a sound insulator having a cylindrical member in which a first transmission region and a second transmission region for transmitting sound are formed.

### SUMMARY

An object of the present disclosure is to provide a sound insulator capable of attenuating sounds in various frequency bands.

According to one aspect of the present disclosure,
a sound insulator includes a space forming portion that forms a transmission space configured to transmit sound waves and has an introduction portion configured to introduce the sound waves into the transmission space and a discharge portion configured to discharge the sound waves introduced into the transmission space to an outside of the transmission space, and a phase adjustment portion that attenuates the sound waves corresponding to a frequency of the sound waves whose phase is changed among the sound waves transmitted through the transmission space by changing the phase of a part of the sound waves transmitted through the transmission space. The phase adjustment portion changes a frequency band of the sound wave whose phase is to be changed.

### BRIEF DESCRIPTION OF THE DRAWINGS

FIG. 1 is a perspective view of a sound insulator according to a first embodiment;

FIG. 2 is a perspective view of an inner cylindrical portion according to the first embodiment;

FIG. 3 is a cross-sectional view taken along line III-III in FIG. 1;

FIG. 4 is an explanatory diagram for explaining sound waves transmitted through a bypass groove according to the first embodiment;

FIG. 5 is an explanatory diagram for explaining sound waves transmitted through a bypass groove when an outer cylindrical portion is rotated;

FIG. 6 is an explanatory diagram for explaining a change in the frequency band of sound waves attenuated by the sound insulator, which changes depending on a bypass length;

FIG. 7 is a perspective view of a sound insulator according to a second embodiment;

FIG. 8 is an explanatory diagram for explaining a restricting protrusion according to the second embodiment;

FIG. 9 is an explanatory diagram for explaining sound waves transmitted through a bypass groove according to the second embodiment;

FIG. 10 is a perspective view of a sound insulator according to a third embodiment;

FIG. 11 is an explanatory diagram for explaining sound waves transmitted through a bypass groove according to the third embodiment;

FIG. 12 is a perspective view of a sound insulator according to a fourth embodiment;

FIG. 13 is a perspective view of a bypass pipe according to the fourth embodiment;

FIG. 14 is an explanatory diagram for explaining a change in the bypass length according to the fourth embodiment;

FIG. 15 is an explanatory diagram for explaining a bypass length when the first cylindrical portion is rotated;

FIG. 16 is a cross-sectional view of a sound insulator according to a fifth embodiment;

FIG. 17 is an enlarged view of XVII part of FIG. 16;

FIG. 18 is a cross-sectional view of a sound insulator according to a sixth embodiment;

FIG. 19 is a cross-sectional view of a sound insulator according to a seventh embodiment;

FIG. 20 is a cross-sectional view of a sound insulator according to a modified example of the seventh embodiment;

FIG. 21 is a perspective view of a sound insulator according to an eighth embodiment;

FIG. 22 is an explanatory diagram for explaining a frequency band of sound waves attenuated by the sound insulator according to the eighth embodiment;

FIG. 23 is a cross-sectional view of a sound insulator according to a ninth embodiment; and

FIG. 24 is an explanatory diagram for explaining a bypass length when a bypass portion is moved.

### DETAILED DESCRIPTION

In an assumable example, a sound insulator has a cylindrical member in which a first transmission region and a second transmission region for transmitting sound are formed. The first transmission region is formed in a cylindrical shape and is surrounded by an inner wall surface of the cylindrical member. The second transmission region is formed in a spiral shape inside the cylindrical member. The cylindrical member has an opening portion on each of one and the other sides in an axial direction. The opening portions communicate with the first transmission region. Furthermore, the cylindrical member has an inlet opening communicating with the second transmission region on an upstream surface on one side in the axial direction, and an outlet opening communicating with the second transmission region on a downstream surface on the other side in the axial direction.

In the sound insulator that is formed in this manner, sound waves introduced from the opening portion on one side in the axial direction of the cylindrical member pass through the first transmission region and are extracted from the opening portion on the other side in the axial direction. Moreover, sound waves introduced from the inlet opening formed on the upstream surface of the cylindrical member pass through the second transmission region and are extracted from the outlet opening formed on the downstream surface. Here, a transmission distance of the first transmission region surrounded by the inner wall surface of the cylindrical member and a transmission distance of the spiral second transmission region formed inside the cylindrical member are different from each other. The first transmission region and the second transmission region are formed so that the phase of the sound wave passing through the first transmission region and being derived from the other side in the axial direction and the phase of the sound wave passing through the second transmission region and being derived from the outlet opening are shifted from each other. The sound insulator configured in this manner attenuates sound by causing the sound that has passed through the first transmission region and the sound that has passed through the second transmission region to interfere with each other.

Incidentally, when noise is attenuated by the sound insulator that attenuates sound, the noise may include a wide frequency band from low to high frequencies. However, when sound is attenuated by the sound insulator, the frequency band of sound that can be attenuated is uniquely determined based on a relationship between the transmission distance of the first transmission region and the transmission distance of the second transmission region. In other words, the sound insulator can only attenuate sounds in a specific frequency band. For this reason, even if the above configuration is applied to the sound insulator, it is difficult to address noise that includes various frequency bands.

In view of the above points, an object of the present disclosure is to provide a sound insulator capable of attenuating sounds in various frequency bands.

According to one aspect of the present disclosure,
a sound insulator includes a space forming portion that forms a transmission space configured to transmit sound waves and has an introduction portion configured to introduce the sound waves into the transmission space and a discharge portion configured to discharge the sound waves introduced into the transmission space to an outside of the transmission space, and a phase adjustment portion that attenuates the sound waves corresponding to a frequency of the sound waves whose phase is changed among the sound waves transmitted through the transmission space by changing the phase of a part of the sound waves transmitted through the transmission space. The phase adjustment portion changes a frequency band of the sound wave whose phase is to be changed.

According to this configuration, since the frequency band of sound waves that can be attenuated can be changed by the phase adjustment portion, sounds in various frequency bands can be attenuated.

Hereinafter, embodiments of the present disclosure will be described with reference to the drawings. In the following embodiments, parts, which are the same as or equivalent to those described in the preceding embodiment(s), will be indicated by the same reference signs, and the description thereof may be omitted. Also, in the following embodiments, when only some of the constituent elements are described, corresponding constituent elements of a previously described one or more of the embodiments may be applied to the rest of the constituent elements. The following embodiments may be partially combined with each other even if such a combination is not explicitly described as long as there is no disadvantage with respect to such a combination.

### First Embodiment

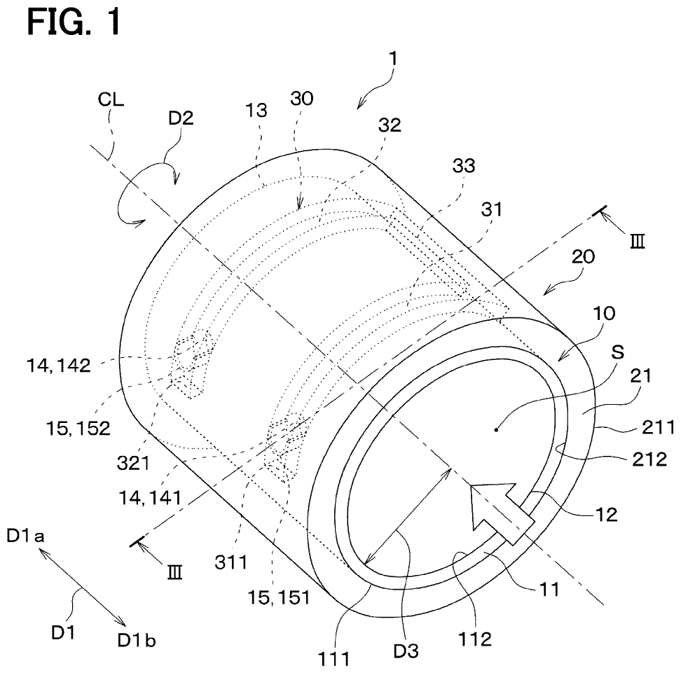

A sound insulator 1 of the present embodiment will be described with reference to FIGS. 1 to 6. In the present embodiment, an example in which the sound insulator 1 is applied to a vehicle will be described. The sound insulator 1 is attached to a vehicle component that generates noise when in operation, such as an electric compressor. The sound insulator 1 is capable of attenuating the volume of noise generated by the vehicle component to which it is attached during operation. When the sound insulator 1 is attached to an electric compressor, the sound insulator 1 may be attached, for example, to a refrigerant pipe through which a refrigerant flows.

The sound insulator 1 is made of, for example, resin. The sound insulator 1 of the present embodiment is made of nylon resin. The material of the sound insulator 1 is not limited to nylon resin. The sound insulator 1 may be made of a resin other than nylon resin, or may be made of a material other than resin, such as a metal.

As shown in FIG. 1, the sound insulator 1 of the present embodiment is configured by combining two cylindrical members extending along a predetermined axial direction. Specifically, the sound insulator 1 has an inner cylindrical portion 10 having a hollow cylindrical shape and an outer cylindrical portion 20 having a hollow cylindrical shape with an outer diameter larger than that of the inner cylindrical portion 10, and is configured by fitting the inner cylindrical portion 10 inside the outer cylindrical portion 20. The inner cylindrical portion 10 and the outer cylindrical portion 20 are formed so that their axes are coaxial. The sound insulator 1 is capable of introducing sound waves to the inner peripheral side of the inner cylindrical portion 10. Hereinafter, an axis of the inner cylindrical portion 10 and the outer cylindrical portion 20 will also be referred to as the axis CL of the sound insulator 1.

Here, as shown in FIG. 1, a direction in which the axis CL of the sound insulator 1 extends is referred to as an axial direction D1, the direction around the axis CL is referred to as a circumferential direction D2, and the direction extending radially from the axis CL is referred to as a radial direction D3. The radial direction D3 is a direction perpendicular to the axial direction D1. In addition, in the axial direction D1, the direction along which sound waves are introduced to the inner peripheral side of the inner cylindrical portion 10 and transmitted is referred to as a transmission direction D1a, and the direction opposite to the transmission direction D1a is referred to as the reverse transmission direction D1b. The sound insulator 1 attenuates sound introduced from the end of the inner cylindrical portion 10 on the side of the reverse transmission direction D1b. In FIG. 1, sound waves introduced into the sound insulator 1 are indicated by outlined arrows.

The inner cylindrical portion 10 and the outer cylindrical portion 20 extend along the axial direction D1, and are formed to have the same size in the axial direction D1. The outer cylindrical portion 20 is disposed outside the inner cylindrical portion 10 in the radial direction D3. The inner diameter of the outer cylindrical portion 20 is slightly larger than the outer diameter of the inner cylindrical portion 10, so that the inner cylindrical portion 10 can be fitted inside the outer cylindrical portion 20. When the inner cylindrical portion 10 is fitted inside the outer cylindrical portion 20, the outer cylindrical portion 20 is capable of rotating in the circumferential direction D2 by a force applied from the outside. However, when the inner cylindrical portion 10 is fitted inside the outer cylindrical portion 20, there is a configuration in which there is almost no gap between the outer cylindrical portion 20 and the inner cylindrical portion 10 so that almost no sound waves are introduced between the outer cylindrical portion 20 and the inner cylindrical portion 10.

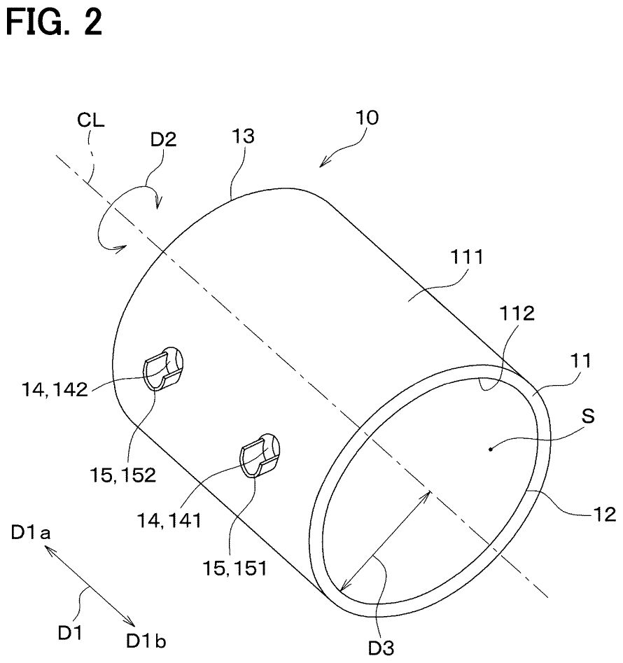

As shown in FIG. 2, the inner cylindrical portion 10 has an inner outer wall part 11 that forms the outer wall of the inner cylindrical portion 10. The inner outer wall part 11 has an inner outer peripheral surface 111 on the outer side in the radial direction D3, and has an inner inner peripheral surface 112 on the inner side in the radial direction D3. The inner outer wall part 11 has a constant dimension from the inner outer peripheral surface 111 to the inner inner peripheral surface 112. The inner outer peripheral surface 111 faces the outer cylindrical portion 20 in the radial direction D3. The inner inner peripheral surface 112 forms a transmission space S inside the inner cylindrical portion 10 through which sound waves are transmitted, and surrounds the transmission space S.

In addition, the inner outer wall part 11 has an introduction opening 12 at its end on the side in the reverse transmission direction D1b for introducing sound waves into the transmission space S, and a discharge opening 13 at its end on the side in the transmission direction D1a for guiding the sound waves introduced into the transmission space S to the outside of the transmission space S. The introduction opening 12 and the discharge opening 13 are open toward the external space, which is the space outside the sound insulator 1, and communicate with the transmission space S. In the present embodiment, the introduction opening 12 corresponds to an introduction portion, and the discharge opening 13 corresponds to a discharge portion.

Furthermore, two through holes 14 and two restricting protrusions 15 are formed in the inner outer wall part 11. The two through holes 14 are formed penetrating the inner outer wall part 11 in the radial direction D3 from the inner outer peripheral surface 111 to the inner inner peripheral surface 112. The two through holes 14 are provided at a predetermined interval in the axial direction D1 and have the same inner diameter. Hereinafter, of the two through holes 14, the one closer to the introduction opening 12 is referred to as an inlet side through hole 141, and the one farther from the introduction opening 12 is referred to as an outlet side through hole 142. The inlet side through hole 141 and the outlet side through hole 142 are formed side by side along the axial direction D1. These inlet side through hole 141 and outlet side through hole 142 communicate with a bypass groove 30 described below.

The two restricting protrusions 15 are provided at positions where the two through holes 14 are formed. The two restricting protrusions 15 are semi-cylindrical in shape and protrude outward in the radial direction D3 from the inner outer peripheral surface 111. That is, the two restricting protrusions 15 are arc-shaped when viewed in a direction perpendicular to the radial direction D3. One of the two restricting protrusions 15 surrounds approximately half of the circumference of the inlet side through hole 141, and the other of the two restricting protrusions 15 surrounds approximately half of the circumference of the outlet side through hole 142. Hereinafter, of the two restricting protrusions 15, the restricting protrusion 15 on the side closer to the introduction opening 12 and surrounding the inlet side through hole 141 is referred to as an inlet side protrusion 151, and the restricting protrusion 15 on the side farther from the introduction opening 12 and surrounding the outlet side through hole 142 is referred to as an outlet side protrusion 152.

As shown in FIG. 1, the outer cylindrical portion 20 has an outer outer wall portion 21 that forms the outer wall of the outer cylindrical portion 20. The outer outer wall portion 21 has an outer outer peripheral surface 211 on the outer side in the radial direction D3, and an outer inner peripheral surface 212 on the inner side in the radial direction D3. The outer outer wall portion 21 has a constant dimension from the outer outer peripheral surface 211 to the outer inner peripheral surface 212, which dimension is larger than the dimension from the inner outer peripheral surface 111 to the inner inner peripheral surface 112 of the inner outer wall part 11. The outer inner peripheral surface 212 faces the inner inner peripheral surface 112 and abuts against the inner inner peripheral surface 112. The inner cylindrical portion 10 and the outer cylindrical portion 20 are integral with each other with the outer inner peripherals surface 212 abutting against the inner inner peripheral surface 112 so as to form the transmission space S. The inner cylindrical portion 10 and the outer cylindrical portion 20 correspond to space forming portions that form the transmission space S.

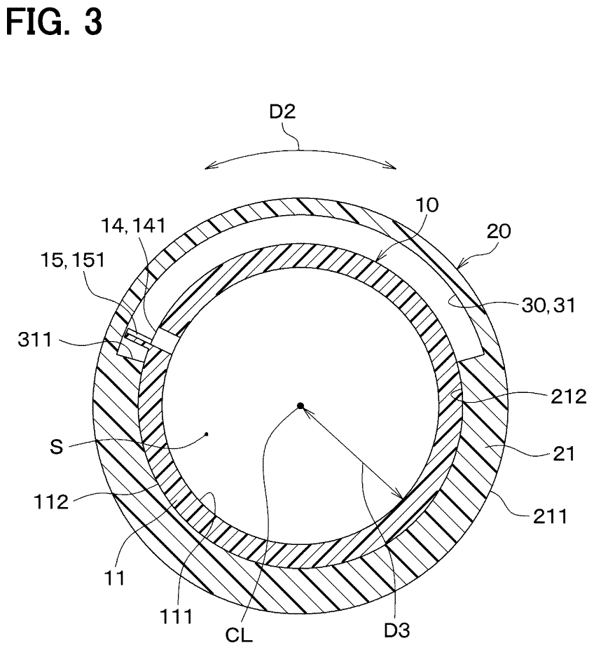

As shown in FIGS. 1 and 3, the outer outer wall portion 21 has a bypass groove 30 formed on the outer inner peripheral surface 212 into which a portion of the sound waves introduced into the transmission space S is guided. The bypass groove 30 is formed by being recessed from the outer inner peripheral surface 212 outward in the radial direction D3. In addition, the bypass groove 30 has an inlet side bypass groove 31 that can face the inlet side through hole 141, an outlet side bypass groove 32 that can face the outlet side through hole 142, and a connecting bypass groove 33 that connects the inlet side bypass groove 31 and the outlet side bypass groove 32. The inlet side bypass groove 31, the outlet side bypass groove 32 and the connecting bypass groove 33 are formed as one continuous groove. When the outer cylindrical portion 20 is fitted into the inner cylindrical portion 10, the inlet side bypass groove 31, the outlet side bypass groove 32 and the connecting bypass groove 33 face the inner outer peripheral surface 111 of the inner cylindrical portion 10, and are thereby covered and blocked by the inner outer peripheral surface 111. That is, the bypass groove 30 constituted by the inlet side bypass groove 31, the outlet side bypass groove 32 and the connecting bypass groove 33 is formed inside the inner cylindrical portion 10 and the outer cylindrical portion 20. In FIG. 1, a part of the outer cylindrical portion 20 is shown in a see-through manner, and the bypass groove 30 is indicated by a dashed line.

The inlet side bypass groove 31 and the outlet side bypass groove 32 have a groove shape extending along the circumferential direction D2 and are formed along the outer inner peripheral surface 212. The inlet side bypass groove 31 and the outlet side bypass groove 32 are formed side by side in the axial direction D1 at a predetermined interval. The inlet side bypass groove 31 and the outlet side bypass groove 32 are formed to have the same dimensions in the circumferential direction D2. In the present embodiment, the size of the inlet side bypass groove 31 and the outlet side bypass groove 32 in the circumferential direction D2 is approximately ⅓ of the inner diameter of the outer cylindrical portion 20. However, the size of the inlet side bypass groove 31 and the outlet side bypass groove 32 in the circumferential direction D2 is not limited, and can be appropriately adjusted so as not to extend over the entire circumference of the outer inner peripheral surface 212. Furthermore, the inlet side bypass groove 31 and the outlet side bypass groove 32 may be formed to have different dimensions in the circumferential direction D2.

The inlet side bypass groove 31 is formed on a side of the reverse transmission direction D1b relative to the outlet side bypass groove 32, and is formed in a position opposite the inlet side through hole 141 in the radial direction D3 when the outer cylindrical portion 20 is fitted into the inner cylindrical portion 10. That is, the inlet side bypass groove 31 is formed at the same position in the axial direction D1 as the inlet side through hole 141. The inlet side bypass groove 31 has one end in the circumferential direction D2 closed by the outer outer wall portion 21 and the other end in the circumferential direction D2 connected to the connecting bypass groove 33. Further, an inlet side protrusion 151 is fitted inside the inlet side bypass groove 31. Hereinafter, one end of the inlet side bypass groove 31 in the circumferential direction D2 is referred to as an inlet side closed end 311.

The size of the inlet side protrusion 151 in the radial direction D3 is approximately the same as the size of the inlet side bypass groove 31 in the radial direction D3, i.e., the depth of the inlet side bypass groove 31. In addition, the inlet side protrusion 151 formed in a semi-cylindrical shape has a size in the axial direction D1 that is approximately the same as the size in the axial direction D1 of the inlet side bypass groove 31, i.e., the width of the groove-shaped inlet side bypass groove 31. However, the inlet side protrusion 151 has a size in the radial direction D3 that is slightly smaller than the depth of the inlet side bypass groove 31, and a size in the axial direction D1 that is slightly smaller than the width of the inlet side bypass groove 31 so as not to hinder the rotation of the outer cylindrical portion 20 in the circumferential direction D2. The semi-cylindrical inlet side protrusion 151 is formed so that its inner peripheral surface side faces the connecting bypass groove 33 side.

The outlet side bypass groove 32 is formed on a side of the transmission direction D1a relative to the inlet side bypass groove 31, and is formed at a position opposite the outlet side through hole 142 in the radial direction D3 when the outer cylindrical portion 20 is fitted into the inner cylindrical portion 10. In other words, the outlet side bypass groove 32 is formed at the same position in the axial direction D1 as the outlet side through hole 142, and is formed at a position farther from the introduction opening 12 than the inlet side bypass groove 31. The outlet side bypass groove 32 has one end in the circumferential direction D2 closed by the outer outer wall portion 21, and the other end in the circumferential direction D2 connected to the connecting bypass groove 33. Further, an outlet side protrusion 152 is fitted inside the outlet side bypass groove 32. Hereinafter, one end of the outlet side bypass groove 32 in the circumferential direction D2 is referred to as an outlet side closed end 321.

The size of the outlet side protrusion 152 in the radial direction D3 is approximately the same as the size of the outlet side bypass groove 32 in the radial direction D3, i.e., the depth of the outlet side bypass groove 32. In addition, the size of the outlet side protrusion 152, which is formed in a semi-cylindrical shape, in the axial direction D1 is approximately the same as the size of the outlet side bypass groove 32 in the axial direction D1, i.e., the width of the groove-shaped outlet side bypass groove 32. However, the outlet side protrusion 152 has a size in the radial direction D3 that is slightly smaller than the depth of the outlet side bypass groove 32, and a size in the axial direction D1 that is slightly smaller than the width of the outlet side bypass groove 32 so as not to hinder the rotation of the outer cylindrical portion 20 in the circumferential direction D2. The semi-cylindrical outlet side protrusion 152 is formed so that its inner peripheral surface side faces the connecting bypass groove 33 side.

The connecting bypass groove 33 has a groove shape that extends along the axial direction D1 and is formed along the outer inner peripheral surface 212. The size of the connecting bypass groove 33 in the axial direction D1 is equal to the distance between the inlet side bypass groove 31 and the outlet side bypass groove 32 in the axial direction D1. For example, the size of the connecting bypass groove 33 in the present embodiment is approximately half the size of the outer cylindrical portion 20 in the axial direction D1. The connecting bypass groove 33 has an end on a side of the reverse transmission direction D1b connected to the inlet side bypass groove 31 and an end on a side of the transmission direction D1a connected to the outlet side bypass groove 32. Therefore, the inlet side bypass groove 31 and the outlet side bypass groove 32 are communicated with each other via the connecting bypass groove 33. In addition, the size in the axial direction D1 of the connecting bypass groove 33 is not limited to approximately half the size of the outer cylindrical portion 20, but is appropriately adjusted according to the distance in the axial direction D1 between the inlet side bypass groove 31 and the outlet side bypass groove 32.

The bypass groove 30, which is formed as a single groove by connecting the inlet side bypass groove 31, the outlet side bypass groove 32 and the connecting bypass groove 33 formed in this manner, is connected to the transmission space S via the inlet side through hole 141 and the outlet side through hole 142. In addition, the inlet side through hole 141, which is formed at a position closer to the introduction opening 12 than the outlet side through hole 142, communicates the transmission space S to the inlet side bypass groove 31, thereby guiding the sound waves introduced into the transmission space S to the inlet side bypass groove 31. The outlet side through hole 142 communicates the outlet side bypass groove 32 to the transmission space S, thereby guiding the sound waves introduced into the outlet side bypass groove 32 via the inlet side bypass groove 31 and the connecting bypass groove 33 to the transmission space S. In the present embodiment, the inlet side through hole 141 corresponds to the inlet portion, and the outlet side through hole 142 corresponds to the outlet portion.

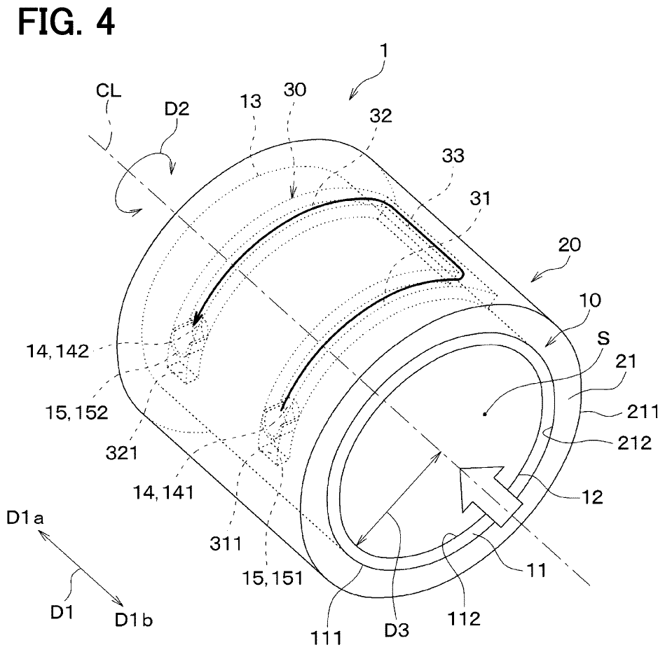

Therefore, the bypass groove 30 enables part of the sound waves introduced into the transmission space S through the introduction opening 12 to be guided to the discharge opening 13 by bypassing part of the transmission space S, thereby enabling the sound waves to be guided outside the sound insulator 1. Specifically, the bypass groove 30 forms a bypass path that bypasses part of the transmission space S by introducing part of the sound waves introduced into the transmission space S through the inlet side through hole 141, passing the sound waves through the bypass groove 30, and guiding them to the transmission space S through the outlet side through hole 142. The sound waves introduced into the bypass groove 30 from the inlet side through hole 141 are transmitted in order through the inlet side bypass groove 31, the connecting bypass groove 33, and the outlet side bypass groove 32, as shown by the arrows in FIG. 4, and are then guided to the outlet side through hole 142 and returned to the transmission space S.

In addition, the inlet side bypass groove 31 is provided with a semi-cylindrical inlet side protrusion 151 that surrounds approximately half of the circumference of the inlet side through hole 141 and is formed so that its inner surface side becomes the connecting bypass groove 33 side. As a result, the sound waves introduced from the inlet side through hole 141 to the inlet side bypass groove 31 are prevented from being transmitted from the inlet side protrusion 151 to the inlet side closed end 311, and their transmission to the connecting bypass groove 33 is promoted. Furthermore, the outlet side bypass groove 32 is provided with a semi-cylindrical outlet side protrusion 152 that surrounds approximately half of the circumference of the outlet side through hole 142 and is formed so that its inner surface side becomes the connecting bypass groove 33 side. As a result, the sound waves introduced into the outlet side bypass groove 32 are prevented from being transmitted from the outlet side protrusion 152 to the outlet side closed end 321, and are promoted from being guided from the outlet side through hole 142 to the transmission space S.

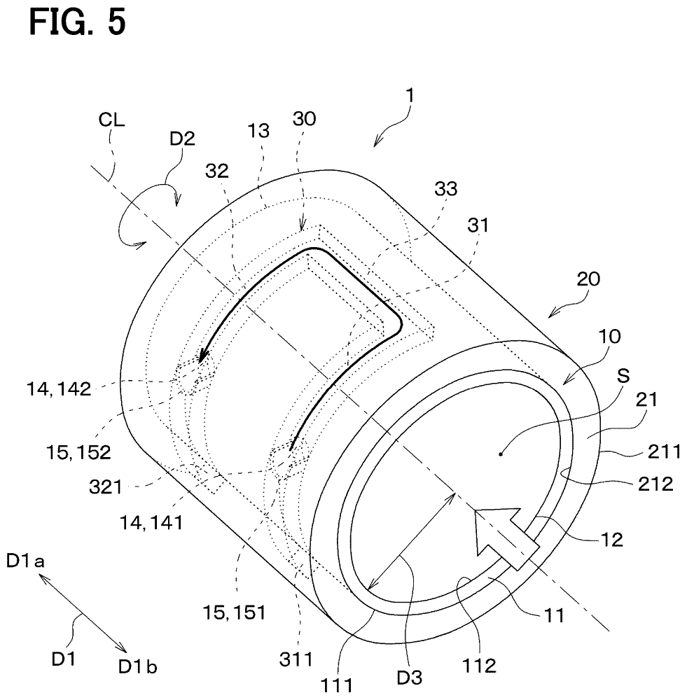

As shown in FIG. 5, in the bypass groove 30, the portion of the inlet side bypass groove 31 facing the inlet side through hole 141 changes as the outer cylindrical portion 20 rotates in the circumferential direction D2. Furthermore, in the bypass groove 30, the portion of the outlet side bypass groove 32 that faces the outlet side through hole 142 can be changed by rotating the outer cylindrical portion 20 in the circumferential direction D2. Furthermore, by changing the portion of the inlet side bypass groove 31 facing the inlet side through hole 141 and the portion of the outlet side bypass groove 32 facing the outlet side through hole 142, the transmission distance of the sound waves from the inlet side through hole 141 to the outlet side through hole 142 can be changed. In other words, the bypass groove 30 is capable of changing the distance of the bypass path that bypasses part of the transmission space S by changing the relative position between the outer cylindrical portion 20 and the inner cylindrical portion 10 in the circumferential direction D2. Hereinafter, the length of the bypass groove 30 from the inlet side through hole 141 to the outlet side through hole 142 is referred to as a bypass length.

In the present embodiment, as the outer cylindrical portion 20 rotates, the bypass length increases as the portion facing the inlet side through hole 141 of the inlet side bypass groove 31 approaches the inlet side closed end 311 and the portion facing the outlet side through hole 142 of the outlet side bypass groove 32 approaches the outlet side closed end 321. That is, as the outer cylindrical portion 20 rotates to one side in the circumferential direction D2 and the inlet side through hole 141 and the outlet side through hole 142 are moved away from the connecting bypass groove 33, the bypass length becomes larger. When the outer cylindrical portion 20 rotates to one side in the circumferential direction D2 to a position where the inlet side protrusion 151 and the outlet side protrusion 152 contact the outer outer wall portion 21, the bypass length becomes maximum.

Furthermore, as the outer cylindrical portion 20 rotates and the portion of the inlet side bypass groove 31 facing the inlet side through hole 141 and the portion of the outlet side bypass groove 32 facing the outlet side through hole 142 approach the connecting bypass groove 33, the bypass length becomes smaller. That is, as the outer cylindrical portion 20 rotates to the other side in the circumferential direction D2 and the inlet side through hole 141 and the outlet side through hole 142 approach the connecting bypass groove 33, the bypass length becomes smaller. When the outer cylindrical portion 20 rotates to the other side in the circumferential direction D2 to a position where the inlet side through hole 141 and the outlet side through hole 142 face the connecting bypass groove 33, the bypass length becomes minimum.

In the sound insulator 1 of the present embodiment, the outer cylindrical portion 20 is rotatable in the circumferential direction D2 by a force applied from the outside. However, the sound insulator 1 may be configured so that the inner cylindrical portion 10 is rotatable in the circumferential direction D2 by a force applied from the outside, and the relative positions of the outer cylindrical portion 20 and the inner cylindrical portion 10 in the circumferential direction D2 may be changeable by rotating the inner cylindrical portion 10 in the circumferential direction D2.

Next, the reason why the bypass groove 30 is formed in the sound insulator 1 of the present embodiment will be described. When operating noise from a vehicle component is generated in the vicinity of the sound insulator 1, the sound insulator 1 is configured that the sound waves associated with the operating noise are introduced through the introduction opening 12 formed at the end of the inner cylindrical portion 10 on the reverse transmission direction D1b side. The sound waves introduced from the introduction opening 12 are transmitted within the transmission space S in the transmission direction D1a and are discharged from the discharge opening 13 formed at the end of the inner cylindrical portion 10 on the transmission direction D1a side.

As described above, in the sound insulator 1 of the present embodiment, the bypass groove 30 is formed between the inner outer peripheral surface 111 and the outer inner peripheral surface 212, and the inlet side through hole 141 and the outlet side through hole 142 are formed in the inner outer wall part 11 for connecting the transmission space S to the bypass groove 30. Therefore, a portion of the sound waves introduced into the transmission space S is introduced into the bypass groove 30 from the inlet side through hole 141 and returned to the transmission space S from the outlet side through hole 142. The bypass groove 30 has the inlet side bypass groove 31 and the outlet side bypass groove 32 formed along the circumferential direction D2.

Therefore, the sound waves transmitted through the bypass groove 30 travel a longer distance within the sound insulator 1 than when the sound waves are transmitted through the transmission space S without transmitting through the bypass groove 30. That is, the sound waves transmitted to the sound insulator 1 include the sound waves transmitted only through the transmission space S and the sound waves transmitted through the transmission space S and the bypass groove 30, and the transmission distances of the respective sound waves are different. Therefore, the sound insulator 1 can change the phase of the sound waves introduced into the bypass groove 30 by transmitting a portion of the sound waves introduced into the transmission space S through the bypass groove 30. The bypass groove 30 corresponds to a phase adjustment portion that changes the phase of a portion of the sound waves introduced into the transmission space S.

When a shift occurs between the phase of the sound waves transmitted only through the transmission space S and the phase of the sound waves transmitted through the transmission space S and the bypass groove 30, the sound waves transmitted only through the transmission space S will interfere with the sound waves returned to the transmission space S via the bypass groove 30. Therefore, the sound insulator 1 can attenuate the intensity of sound waves in a specific frequency band that corresponds to the frequency band of sound waves transmitted through the bypass groove 30, among the sound waves transmitted within the transmission space S. Therefore, the sound insulator 1 can attenuate the sound that occurs in the vicinity of the sound insulation part 1 and that corresponds to the specific frequency band. Furthermore, when the phase of the sound waves transmitted only through the transmission space S and the phase of the sound waves transmitted through the bypass groove 30 are in opposite phase, the sound insulator 1 can attenuate more significantly the sound corresponding to the frequency band of the sound waves transmitted through the bypass groove 30.

For this reason, the bypass groove 30 of the present embodiment changes the phase of the sound waves that have passed through the bypass groove 30 so that the phase of the sound wave transmitted to the outlet side through hole 142 through the bypass groove 30 is close to the inverse phase of the phase of the sound wave transmitted to the outlet side through hole 142 without passing through the bypass groove 30. Here, a phase shift amount Δφ is the amount of shift between the phase of the sound wave transmitted to the outlet side through hole 142 through the bypass groove 30 and the phase of the sound wave transmitted to the outlet side through hole 142 without passing through the bypass groove 30. The bypass groove 30 is configured to be capable of changing the phase of the sound wave that has passed through the bypass groove 30 so as to satisfy the following equation 1.

+150+(N×360)≤Δφ≤+210+(N×360) (Equation 1)

Furthermore, as described above, when the phase of the sound waves transmitted through the bypass groove 30 to the outlet side through hole 142 becomes the opposite phase to the phase of the sound waves transmitted to the outlet side through hole 142 without passing through the bypass groove 30, the sound insulator 1 can attenuate the sound more significantly. For this reason, it is more preferable that the bypass groove 30 of the present embodiment is configured to be capable of changing the phase of the sound wave that has passed through the bypass groove 30 so as to satisfy the following equation 2. In addition, N in Equation 1 and Equation 2 is an integer used as an arbitrary coefficient.

Δφ=±180+(N×360) (Equation 2)

The frequency band attenuated in the sound wave transmitted only through the transmission space S changes depending on the bypass length. Specifically, the frequency band attenuated by interference with the sound waves returned to the transmission space S via the bypass groove 30 becomes lower as the bypass length becomes longer, and becomes higher as the bypass length becomes shorter. Therefore, the longer the bypass length, the lower the frequency band of sound waves that can attenuate the intensity of sound waves transmitted through the transmission space S. Furthermore, the shorter the bypass length, the higher the frequency band of sound waves that can be attenuated in intensity in the sound waves transmitted within the transmission space S. That is, the frequency band of the sound waves, the phase of which is changed by being introduced into the bypass groove 30, can be changed according to the bypass length.

As described above, the length of the bypass path changes depending on the relative positions of the outer cylindrical portion 20 and the inner cylindrical portion 10 in the circumferential direction D2. Therefore, by rotating the outer cylindrical portion 20 in the circumferential direction D2, the frequency band of sound that is attenuated by the sound insulator 1 can be changed.

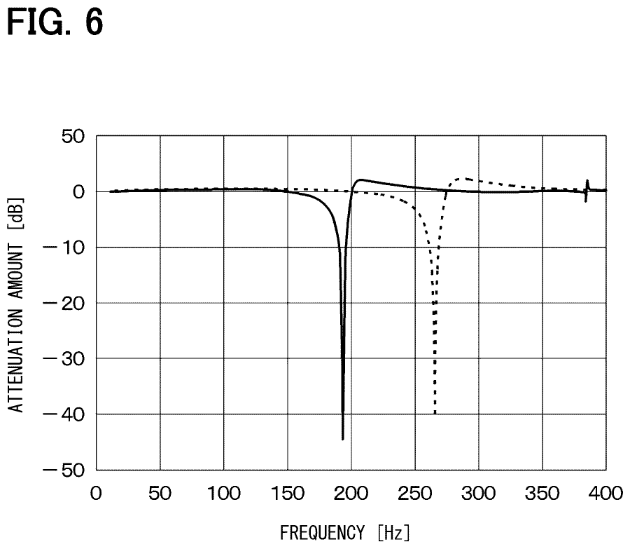

The change in the frequency band attenuated by the sound insulator 1 depending on the bypass length will be described with reference to FIG. 6. The solid line in FIG. 6 indicates the amount of sound attenuation by the sound insulator 1 when the rotational position of the outer cylindrical portion 20 is set to the position shown in FIG. 4. The dashed line in FIG. 6 indicates the amount of sound attenuation by the sound insulator 1 when the rotational position of the outer cylindrical portion 20 is set to the position shown in FIG. 5. As shown in FIGS. 4 and 5, the bypass length when the outer cylindrical portion 20 is in the position shown in FIG. 4 is longer than the bypass length when the outer cylindrical portion 20 is in the position shown in FIG. 5.

Therefore, by rotating the outer cylindrical portion 20 to one side in the circumferential direction D2 so as to increase the bypass length, the frequency band of sounds that can be attenuated by the sound insulator 1 can be lowered, as shown in FIG. 6. In contrast to this configuration, by rotating the outer cylindrical portion 20 to the other side in the circumferential direction D2 so as to shorten the bypass length, the frequency band of sounds that can be attenuated by the sound insulator 1 can be increased. Furthermore, by adjusting the rotational position of the outer cylindrical portion 20 so that the phase of the sound waves transmitted only through the transmission space S and the phase of the sound waves transmitted through the bypass groove 30 are in opposite phase, the sound insulator 1 can more significantly attenuate sound in the frequency band corresponding to the bypass length.

As described above, the sound insulator 1 of the present embodiment includes the inner cylindrical portion 10 and the outer cylindrical portion 20 which have the introduction opening 12 that forms a transmission space S for transmitting sound waves and introduces sound waves into the transmission space S and the discharge opening 13 for guiding the sound waves introduced into the transmission space S to the outside of the transmission space S. The sound insulator 1 includes the bypass groove 30 that attenuates sound waves corresponding to the frequency of the sound waves whose phases have been changed among the sound waves transmitted through the transmission space S by changing the phase of some of the sound waves transmitted through the transmission space S. The bypass groove 30 changes the frequency band of the sound waves whose phase is changed.

According to this configuration, the bypass groove 30 can change the frequency band of sound waves that the sound insulator 1 can attenuate, so that sounds of various frequency bands that are guided from the transmission space S to the outside through the discharge opening 13 can be attenuated.

According to the above embodiment, it is possible to attain the following advantageous effects.
(1) In the above embodiment, the bypass groove 30, which guides a part of the sound waves introduced from the introduction opening 12 into the transmission space S to the discharge opening 13 by bypassing a portion of the transmission space S, is capable of changing the length of the bypass path from the inlet side through hole 141 to the outlet side through hole 142. This makes it possible to realize a configuration in which the bypass length can be changed by the bypass groove 30.
(2) In the above embodiment, the bypass groove 30 is formed inside the inner cylindrical portion 10 and the outer cylindrical portion 20. This allows the structure of the sound insulator 1 to be simpler than a structure in which a separate bypass path is provided outside the inner cylindrical portion 10 and the outer cylindrical portion 20.
(3) In the above embodiment, the sound insulator 1 includes the inner cylindrical portion 10 that extends along the axial direction D1 and is formed in a hollow cylindrical shape to define the transmission space S. Furthermore, the sound insulator 1 includes the outer cylindrical portion 20 that extends along the axial direction D1 and is disposed outside the inner cylindrical portion 10 to surround the outer periphery of the inner cylindrical portion 10. The inner cylindrical portion 10 has the inner outer peripheral surface 111 facing the outer cylindrical portion 20, the inner inner peripheral surface 112 surrounding the transmission space S, and the inlet side through hole 141 and the outlet side through hole 142 formed by penetrating the inner outer wall part 11 and arranged at a predetermined interval in the axial direction D1. The outer cylindrical portion 20 has the outer inner peripheral surface 212 that faces the inner outer peripheral surface 111 and abuts against the inner outer peripheral surface 111, and is rotatable in the circumferential direction D2. The bypass groove 30 is formed in a groove shape at a position opposite the inlet side through hole 141 and the outlet side through hole 142 on the outer inner peripheral surface 212, and the bypass length changes depending on the change in the relative position in the circumferential direction D2 between the inner cylindrical portion 10 and the outer cylindrical portion 20.

According to this configuration, the frequency band of sounds that can be attenuated can be changed by changing the relative position between the outer cylindrical portion 20 and the inner cylindrical portion 10.

### Modification of First Embodiment

In the above-described first embodiment, an example has been described in which one inlet side through hole 141 and one outlet side through hole 142 are formed in the inner cylindrical portion 10, but the present disclosure is not limited to this configuration. For example, a plurality of inlet side through holes 141 and a plurality of outlet side through holes 142 may be formed. In this case, the additional hole may be formed at a position facing either the inlet side bypass groove 31 or the outlet side bypass groove 32. Alternatively, the shape of the bypass groove 30 can be changed depending on the position of the added hole, and a groove extending in the circumferential direction D2 may be added at a position opposite the added hole.

### Second Embodiment

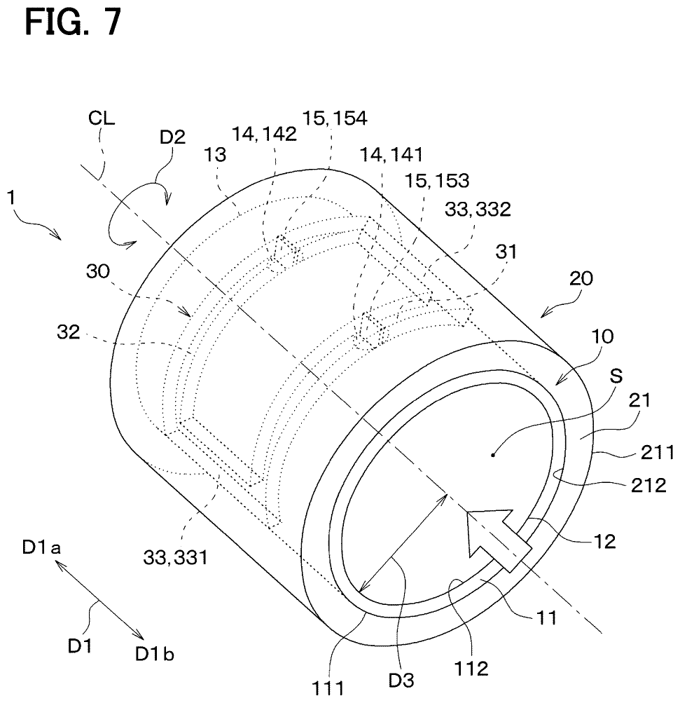

Next, a second embodiment will be described with reference to FIGS. 7 to 9. In the present embodiment, the shapes of the bypass groove 30 and the restricting protrusion 15 are different from those in the first embodiment. The other configurations are the same as those of the first embodiment. Therefore, in the present embodiment, portions different from the first embodiment will be mainly described, and description of portions similar to the first embodiment may be omitted.

As shown in FIG. 7, the bypass groove 30 of the present embodiment has two connecting bypass grooves 33 that connect the inlet side bypass groove 31 and the outlet side bypass groove 32. That is, the bypass groove 30 in the present embodiment has an inlet side bypass groove 31, an outlet side bypass groove 32, and two connecting bypass grooves 33. The inlet side bypass groove 31, the outlet side bypass groove 32 and the two connecting bypass groove 33 are formed as one continuous groove. Hereinafter, of the two connecting bypass grooves 33, the one on one side in the circumferential direction D2 will be referred to as a first connecting bypass groove 331, and the other on the other side in the circumferential direction D2 will be referred to as a second connecting bypass groove 332. In FIG. 7, a portion of the outer cylindrical portion 20 is shown in a see-through manner, and the inlet side bypass groove 31, the outlet side bypass groove 32, the first connecting bypass groove 331, and the second connecting bypass groove 332 are indicated by dashed lines. Moreover, the inlet side bypass groove 31 and the outlet side bypass groove 32 have the same shape and configuration as those in the first embodiment, and therefore detailed description thereof will be omitted.

The first connecting bypass groove 331 and the second connecting bypass groove 332 have a groove shape extending along the axial direction D1 and are formed along the outer inner peripheral surface 212. The first connecting bypass groove 331 and the second connecting bypass groove 332 are formed side by side in the circumferential direction D2 at a predetermined interval. The first connecting bypass groove 331 and the second connecting bypass groove 332 have the same dimensions in the axial direction D1, and each dimension in the axial direction D1 is equal to the distance between the inlet side bypass groove 31 and the outlet side bypass groove 32.

In addition, the first connecting bypass groove 331 and the second connecting bypass groove 332 have their respective ends in the reverse transmission direction D1b connected to the inlet side bypass groove 31, and their respective ends in the transmission direction D1a connected to the outlet side bypass groove 32. Therefore, the inlet side bypass groove 31 and the outlet side bypass groove 32 are communicated at one end in the circumferential direction D2 via the first connecting bypass groove 331. The inlet side bypass groove 31 and the outlet side bypass groove 32 are communicated at their ends on the other side in the circumferential direction D2 via the second connecting bypass groove 332. Therefore, in the present embodiment, the inlet side bypass groove 31 and the outlet side bypass groove 32 have one end in the circumferential direction D2 that is not closed by the outer outer wall portion 21. The bypass groove 30 is formed in an annular shape.

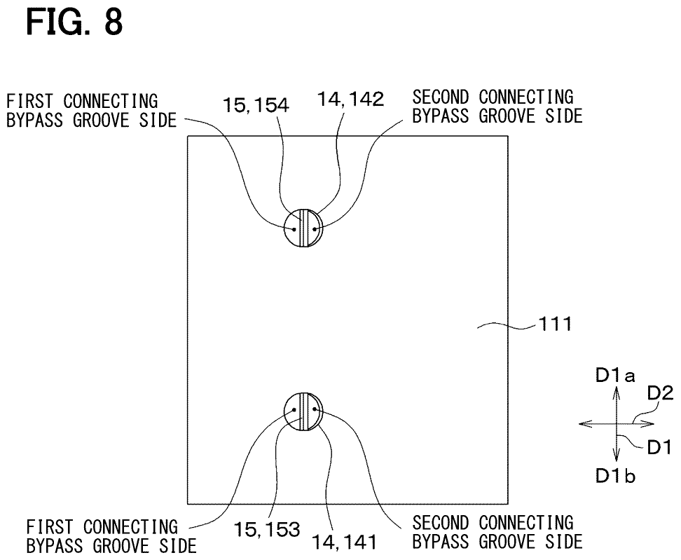

Also, as shown in FIG. 8, unlike the first embodiment, the restricting protrusion 15 of the present embodiment is formed in a thin plate shape having a plate surface in the circumferential direction D2. That is, the restricting protrusion 15 has a rectangular shape extending in the axial direction D1 when viewed in a direction perpendicular to the radial direction D3. The restricting protrusion 15 is formed to protrude outward in the radial direction D3 from the inner outer peripheral surface 111. Hereinafter, of the two restricting protrusions 15, the one closer to the introduction opening 12 is referred to as the inlet side branch portion 153, and the one farther from the introduction opening 12 is referred to as the outlet side branch portion 154.

The inlet side branch portion 153 passes through the center of the inlet side through hole 141 and is provided across the opening of the inlet side through hole 141. However, the inlet side branch portion 153 is formed so that its size in the plate thickness direction is smaller than the inner diameter of the inlet side through hole 141 so as not to close the opening portion of the inlet side through hole 141. The inlet side branch portion 153 divides the opening portion of the inlet side through hole 141 into two. Therefore, the opening of the inlet side through hole 141 is divided by the inlet side branch portion 153 into the first connecting bypass groove 331 side and the second connecting bypass groove 332 side.

The inlet side branch portion 153 has a size in the radial direction D3 that is approximately the same as the depth of the inlet side bypass groove 31, and a size in the axial direction D1 that is approximately the same as the width of the inlet side bypass groove 31. In addition, the size of the inlet side branch portion 153 in the axial direction D1 is slightly smaller than the width of the inlet side bypass groove 31 so as not to impede rotation of the outer cylindrical portion 20 in the circumferential direction D2. The inlet side branch portion 153 is formed so that a plate surface on one side in the circumferential direction D2 is located on the first connecting bypass groove 331 side, and a plate surface on the other side in the circumferential direction D2 is located on the second connecting bypass groove 332 side.

The outlet side branch portion 154 passes through the center of the outlet side through hole 142 and is provided across the opening of the outlet side through hole 142. However, the outlet side branch portion 154 is formed so that its size in the plate thickness direction is smaller than that of the outlet side through hole 142 so as not to block the opening of the outlet side through hole 142. The outlet side branch portion 154 divides the opening of the outlet side through hole 142 into two. Therefore, the opening of the outlet side through hole 142 is partitioned by the outlet side branch portion 154 into the first connecting bypass groove 331 side and the second connecting bypass groove 332 side.

The size of the outlet side branch portion 154 in the radial direction D3 is approximately the same as the depth of the outlet side bypass groove 32, and the size of the outlet side branch portion 154 in the axial direction D1 is approximately the same as the width of the outlet side bypass groove 32. In addition, the size of the outlet side branch portion 154 in the axial direction D1 is slightly smaller than the width of the outlet side bypass groove 32 so as not to impede rotation of the outer cylindrical portion 20 in the circumferential direction D2. The outlet side branch portion 154 is formed so that a plate surface on one side in the circumferential direction D2 is located on the first connecting bypass groove 331 side, and a plate surface on the other side in the circumferential direction D2 is located on the second connecting bypass groove 332 side.

The bypass groove 30 of the present embodiment formed in this manner communicates with the transmission space S via the inlet side through hole 141 and the outlet side through hole 142. Therefore, the bypass groove 30 enables part of the sound waves introduced into the transmission space S through the introduction opening 12 to be guided to the discharge opening 13 by bypassing part of the transmission space S, thereby enabling the sound waves to be guided outside the sound insulator 1. Specifically, the bypass groove 30 forms a bypass path that bypasses part of the transmission space S by introducing part of the sound waves introduced into the transmission space S through the inlet side through hole 141, passing the sound waves through the bypass groove 30, and guiding them to the transmission space S through the outlet side through hole 142.

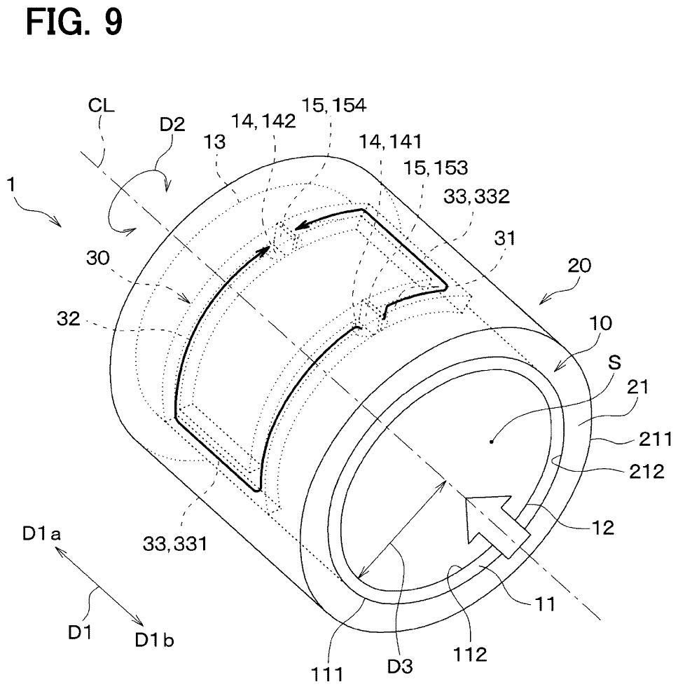

Here, the inlet side bypass groove 31 of the present embodiment is provided with the inlet side branch portion 153 that divides the opening portion of the inlet side through hole 141 into one side and the other side in the circumferential direction D2. Therefore, the sound waves introduced from the inlet side through hole 141 to the inlet side bypass groove 31 are branched and transmitted to one side and the other side in the circumferential direction D2 by the inlet side branch portion 153, as shown by the arrows in FIG. 9. Then, the sound waves transmitted from the inlet side branch portion 153 to one side in the circumferential direction D2 are transmitted from the one side in the circumferential direction D2 to the outlet side bypass groove 32 via the first connecting bypass groove 331. In addition, the sound waves transmitted from the inlet side branch portion 153 to the other side in the circumferential direction D2 are transmitted from the other side in the circumferential direction D2 to the outlet side bypass groove 32 via the second connecting bypass groove 332.

The outlet side bypass groove 32 is provided with the outlet side branch portion 154 that divides the opening portion of the outlet side through hole 142 into one side and the other side in the circumferential direction D2. Therefore, the sound waves introduced into the outlet side bypass groove 32 from one side in the circumferential direction D2 via the first connecting bypass groove 331 are discharged from the outlet side through hole 142 in a state separated from the sound waves introduced into the outlet side bypass groove 32 from the other side in the circumferential direction D2 via the second connecting bypass groove 332.

Therefore, the bypass groove 30 of the present embodiment forms a bypass path that branches a portion of the sound waves introduced into the inside of the sound insulator 1 to one side and the other side in the circumferential direction D2, thereby bypassing a portion of the transmission space S. Then, the sound waves transmitted from the inlet side through hole 141 to one side in the circumferential direction D2 are transmitted in order through the inlet side bypass groove 31, the first connecting bypass groove 331, and the outlet side bypass groove 32, as shown in FIG. 9, and are guided to the outlet side through hole 142 and returned to the transmission space S. In addition, the sound waves transmitted from the inlet side through hole 141 to the other side in the circumferential direction D2 are transmitted in order through the inlet side bypass groove 31, the second connecting bypass groove 332, and the outlet side bypass groove 32, and are guided to the outlet side through hole 142 and returned to the transmission space S. The inlet side bypass groove 31, the first connecting bypass groove 331, and the outlet side bypass groove 32 correspond to one side groove portion, and the inlet side bypass groove 31, the second connecting bypass groove 332, and the outlet side bypass groove 32 correspond to the other side groove portion.

As a result, in the sound waves transmitted within the transmission space S, the intensity of the sound waves corresponding to the frequency band of the sound waves returned to the transmission space S via the first connecting bypass groove 331 and the intensity of the sound waves corresponding to the frequency band of the sound waves returned to the transmission space S via the second connecting bypass groove 332 are attenuated.

In addition, when the outer cylindrical portion 20 rotates in the circumferential direction D2, the bypass groove 30 is capable of changing the transmission distance of the sound waves guided out from the outlet side through hole 142 via the first connecting bypass groove 331 and the transmission distance of the sound waves guided out from the outlet side through hole 142 via the second connecting bypass groove 332. In other words, the bypass groove 30 is capable of changing the distance of two bypass paths that bypasses part of the transmission space S by changing the relative position between the outer cylindrical portion 20 and the inner cylindrical portion 10 in the circumferential direction D2. Hereinafter, of the length of the bypass groove 30 from the inlet side through hole 141 to the outlet side through hole 142, the length passing through the first connecting bypass groove 331 is referred to as the first bypass length, and the length passing through the second connecting bypass groove 332 is referred to as the second bypass length.

In the present embodiment, as the outer cylindrical portion 20 rotates, the first bypass length becomes smaller as the portion facing the inlet side through hole 141 of the inlet side bypass groove 31 approaches the first connecting bypass groove 331 and the portion facing the outlet side through hole 142 of the outlet side bypass groove 32 approaches the second connecting bypass groove 332. That is, the more the outer cylindrical portion 20 rotates to one side in the circumferential direction D2, the shorter the first bypass length becomes. The more the outer cylindrical portion 20 rotates to one side in the circumferential direction D2, the longer the second bypass length becomes. Furthermore, when the outer cylindrical portion 20 rotates in the circumferential direction D2 to a position where the inlet side branch portion 153 and the outlet side branch portion 154 face the first connecting bypass groove 331, the first bypass length becomes minimum and the second bypass length becomes maximum.

Furthermore, as the outer cylindrical portion 20 rotates and the portion of the inlet side bypass groove 31 facing the inlet side through hole 141 and the portion of the outlet side bypass groove 32 facing the outlet side through hole 142 approach the second connecting bypass groove 332, the first bypass length becomes larger. That is, the more the outer cylindrical portion 20 rotates to the other side in the circumferential direction D2, the shorter the first bypass length becomes. The more the outer cylindrical portion 20 rotates toward the other side in the circumferential direction D2, the shorter the second bypass length becomes. Furthermore, when the outer cylindrical portion 20 rotates in the circumferential direction D2 to a position where the inlet side through hole 141 and the outlet side through hole 142 face the second connecting bypass groove 332, the first bypass length becomes maximum and the second bypass length becomes minimum. The sound insulator 1 can change the frequency band of the sound waves, the phase of which is changed by being introduced into the bypass groove 30, depending on the first bypass length and the second bypass length, respectively.

Therefore, by rotating the outer cylindrical portion 20 in the circumferential direction D2, the frequency bands of sounds that can be attenuated by each of the first connecting bypass groove 331 and the second connecting bypass groove 332 can be changed. Specifically, by rotating the outer cylindrical portion 20 to one side in the circumferential direction D2 to shorten the first bypass length, it is possible to increase the frequency band of sound that corresponds to the first bypass length among the frequency bands of sound that can be attenuated by the sound insulator 1. Furthermore, by rotating the outer cylindrical portion 20 to one side in the circumferential direction D2 to lengthen the second bypass length, it is possible to lower the frequency band of sound that corresponds to the second bypass length among the frequency bands of sound that can be attenuated by the sound insulator 1.

In contrast to this configuration, by rotating the outer cylindrical portion 20 to the other side in the circumferential direction D2 to lengthen the first bypass length, it is possible to lower the frequency band of sound that corresponds to the first bypass length among the frequency bands of sound that can be attenuated by the sound insulator 1. Furthermore, by rotating the outer cylindrical portion 20 to the other side in the circumferential direction D2 to shorten the second bypass length, it is possible to increase the frequency band of sound that corresponds to the second bypass length among the frequency bands of sound that can be attenuated by the sound insulator 1.

As described above, the bypass groove 30 has the inlet side bypass groove 31, the first connecting bypass groove 331, and the outlet side bypass groove 32, which transmit sound waves transmitted from the inlet side through hole 141 to the bypass groove 30 to one side in the circumferential direction D2 and guide them to the outlet side through hole 142. In addition, the bypass groove 30 has the inlet side bypass groove 31, the second connecting bypass groove 332, and the outlet side bypass groove 32, which transmit the sound waves transmitted from the inlet side through hole 141 to the bypass groove 30 to the other side in the circumferential direction D2 and guide them to the outlet side through hole 142.

According to this configuration, the sound insulator 1 can reduce the frequency band of sound corresponding to the first bypass length, and attenuate the frequency band of sound corresponding to the second bypass length. In addition, the outer cylindrical portion 20 can be rotated in the circumferential direction D2 to change the frequency band of sound waves that the sound insulator 1 can attenuate using the bypass groove 30, thereby making it possible to attenuate sounds of various frequency bands that are emitted from the transmission space S to the outside through the discharge opening 13.

### Third Embodiment

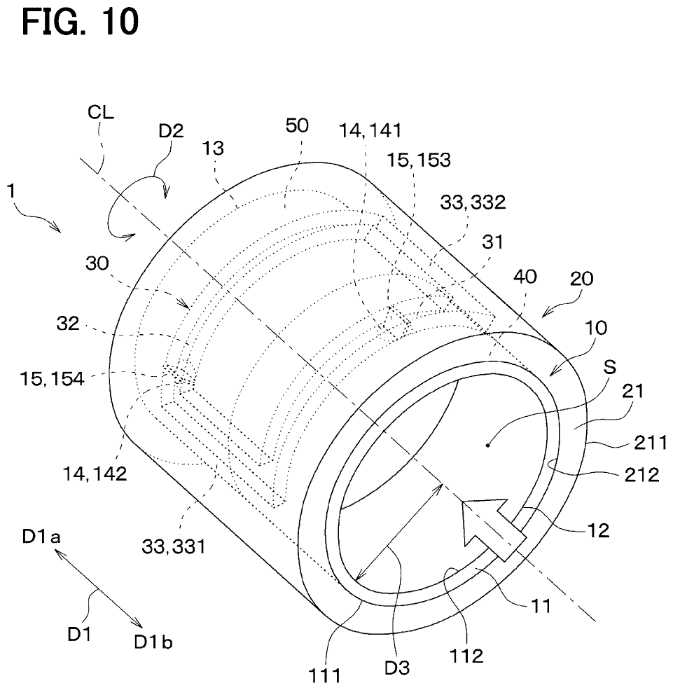

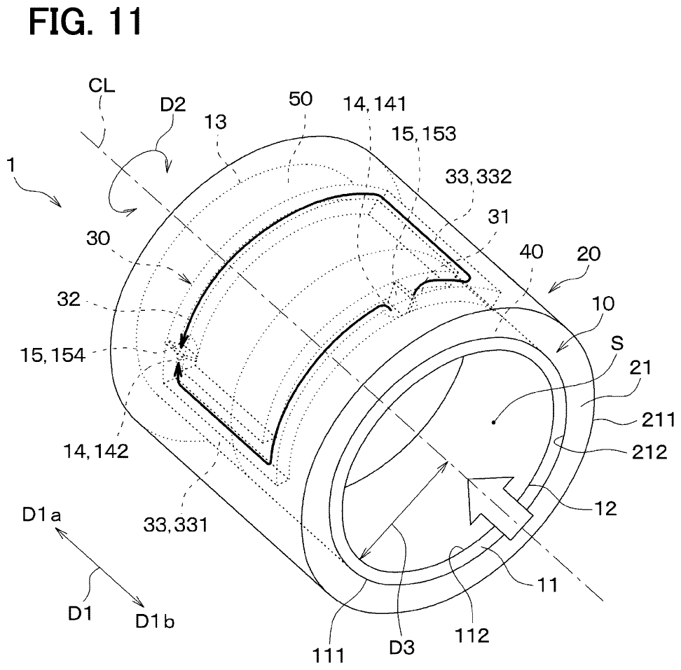

Next, a third embodiment will be described with reference to FIGS. 10 and 11. In the present embodiment, the configuration of the inner cylindrical portion 10 is different from that of the second embodiment. The other configurations are the same as those of the second embodiment. Therefore, in the present embodiment, portions different from the second embodiment will be mainly described, and description of portions similar to the second embodiment may be omitted.

As shown in FIG. 10, the inner cylindrical portion 10 of the present embodiment is configured with two cylindrical members arranged side by side in the axial direction D1. Specifically, the inner cylindrical portion 10 is configured with a first inner cylindrical portion 40 arranged on the reverse transmission direction D1b side in the axial direction D1 and a second inner cylindrical portion 50 arranged on the transmission direction D1a side, which are connected in the axial direction D1. That is, the inner cylindrical portion 10 in the present embodiment is divided into the first inner cylindrical portion 40 and the second inner cylindrical portion 50. In the present embodiment, the inner cylindrical portion 10 is divided substantially at the center in the axial direction D1. The first inner cylindrical portion 40 and the second inner cylindrical portion 50 have the same size in the axial direction D1. The first inner cylindrical portion 40 and the second inner cylindrical portion 50 correspond to divided inner cylindrical portions.

An inlet side through hole 141 is formed in the first inner cylindrical portion 40. The inlet side through hole 141 is formed in approximately the center of the first inner cylindrical portion 40 in the axial direction D1. An outlet side through hole 142 is formed in the second inner cylindrical portion 50. The outlet side through hole 142 is formed in approximately the center of the second inner cylindrical portion 50 in the axial direction D1.

In addition, when the outer cylindrical portion 20 is fitted around the outside of the first inner cylindrical portion 40 and the second inner cylindrical portion 50, the first inner cylindrical portion 40 and the second inner cylindrical portion 50 are capable of rotating in the circumferential direction D2 by a force applied thereto from the outside. That is, in the sound insulator 1, the relative position between the outer cylindrical portion 20 and the first inner cylindrical portion 40 in the circumferential direction D2 can be changed by the first inner cylindrical portion 40 rotating in the circumferential direction D2. Furthermore, in the sound insulator 1, the relative position between the outer cylindrical portion 20 and the second inner cylindrical portion 50 in the circumferential direction D2 can be changed by the second inner cylindrical portion 50 rotating in the circumferential direction D2.

Here, the first inner cylindrical portion 40 and the second inner cylindrical portion 50 are rotatable to one side and the other side in the circumferential direction D2 independently of each other. For example, when one of the first inner cylindrical portion 40 and the second inner cylindrical portion 50 rotates in one side in the circumferential direction D2 by a force applied thereto from the outside, the other thereof can rotate in the other side in the circumferential direction D2. Furthermore, the first inner cylindrical portion 40 and the second inner cylindrical portion 50 are capable of maintaining a state in which, when one of them rotates in the circumferential direction D2 by a force applied thereto from the outside, the other does not rotate. Therefore, in the inner cylindrical portion 10 of the present embodiment, as shown in FIG. 10, the inlet side through hole 141 and the outlet side through hole 142 can be arranged not to be aligned in the axial direction D1.

In the present embodiment in which the inner cylindrical portion 10 is formed in this manner, as shown in FIG. 11, sound waves introduced from the inlet side through hole 141 to the inlet side bypass groove 31 are transmitted to the outlet side bypass groove 32 via the first connecting bypass groove 331. In addition, the sound waves introduced from the inlet side through hole 141 to the inlet side bypass groove 31 are transmitted to the outlet side bypass groove 32 via the second connecting bypass groove 332. In the present embodiment, in which the inner cylindrical portion 10 is thus constituted by the first inner cylindrical portion 40 and the second inner cylindrical portion 50, the first bypass length and the second bypass length can be changed by rotating the first inner cylindrical portion 40 and the second inner cylindrical portion 50.

Specifically, as the first inner cylindrical portion 40 rotates and the portion of the inlet side bypass groove 31 facing the inlet side through hole 141 approaches the first connecting bypass groove 331, the first bypass length becomes smaller, and in contrast, the second bypass length becomes larger. That is, as the first inner cylindrical portion 40 rotates toward one side in the circumferential direction D2, the first bypass length becomes smaller and the second bypass length becomes larger. Furthermore, as the first inner cylindrical portion 40 rotates and the portion of the inlet side bypass groove 31 facing the inlet side through hole 141 approaches the second connecting bypass groove 332, the first bypass length becomes larger, and in contrast, the second bypass length becomes smaller. That is, as the first inner cylindrical portion 40 rotates toward the other side in the circumferential direction D2, the first bypass length becomes longer and the second bypass length becomes shorter.

As the second inner cylindrical portion 50 rotates and the portion of the outlet side bypass groove 32 facing the outlet side through hole 142 approaches the first connecting bypass groove 331, the first bypass length becomes smaller, and in contrast, the second bypass length becomes larger. That is, as the second inner cylindrical portion 50 rotates toward one side in the circumferential direction D2, the first bypass length becomes smaller and the second bypass length becomes larger. Furthermore, as the second inner cylindrical portion 50 rotates and the portion of the outlet side bypass groove 32 facing the outlet side through hole 142 approaches the second connecting bypass groove 332, the first bypass length becomes larger, and in contrast, the second bypass length becomes smaller. That is, as the second inner cylindrical portion 50 rotates toward the other side in the circumferential direction D2, the first bypass length becomes longer and the second bypass length becomes shorter.

Therefore, by rotating the first inner cylindrical portion 40 and the second inner cylindrical portion 50 in the circumferential direction D2, the frequency bands of sounds that can be attenuated by the first connecting bypass groove 331 and the second connecting bypass groove 332, respectively, can be changed. Specifically, by rotating at least one of the first inner cylindrical portion 40 and the second inner cylindrical portion 50 to one side in the circumferential direction D2, it is possible to increase the frequency band of sound that corresponds to the first bypass length among the frequency bands of sound that can be attenuated by the sound insulator 1. Furthermore, by rotating at least one of the first inner cylindrical portion 40 and the second inner cylindrical portion 50 to one side in the circumferential direction D2, it is possible to lower the frequency band of sound that corresponds to the second bypass length among the frequency bands of sound that can be attenuated by the sound insulator 1.

In contrast to this configuration, by rotating at least one of the first inner cylindrical portion 40 and the second inner cylindrical portion 50 to the other side in the circumferential direction D2, it is possible to lower the frequency band of sound that corresponds to the first bypass length among the frequency bands of sound that can be attenuated by the sound insulator 1. Furthermore, by rotating at least one of the first inner cylindrical portion 40 and the second inner cylindrical portion 50 to the other side in the circumferential direction D2, it is possible to increase the frequency band of sound that corresponds to the second bypass length among the frequency bands of sound that can be attenuated by the sound insulator 1.

As described above, the inner cylindrical portion 10 has the first inner cylindrical portion 40 having the inlet side through hole 141 formed therein and the second inner cylindrical portion 50 having the outlet side through hole 142 formed therein, which are aligned in the axial direction D1. The first inner cylindrical portion 40 and the second inner cylindrical portion 50 are rotatable in the circumferential direction D2 independently of each other.

According to this configuration, the sound insulator 1 can reduce the frequency band of sound corresponding to the first bypass length, and attenuate the frequency band of sound corresponding to the second bypass length. In addition, the outer cylindrical portion 20 can be rotated in the circumferential direction D2 to change the frequency band of sound waves that the sound insulator 1 can attenuate using the bypass groove 30, thereby making it possible to attenuate sounds of various frequency bands that are emitted from the transmission space S to the outside through the discharge opening 13. Furthermore, compared to a case in which the sound insulator 1 is not constituted by the first inner cylindrical portion 40 and the second inner cylindrical portion 50, the first bypass length and the second bypass length can be adjusted more easily.

### Modified Example of Third Embodiment

In the above-described third embodiment, an example has been described in which the inner cylindrical portion 10 is divided into two portions, the first inner cylindrical portion 40 and the second inner cylindrical portion 50, but the present disclosure is not limited to this configuration. For example, the inner cylindrical portion 10 may be divided into three or more cylindrical members, and each of the divided cylindrical members may have a hole formed therein corresponding to either the inlet side through hole 141 or the outlet side through hole 142.

### Fourth Embodiment

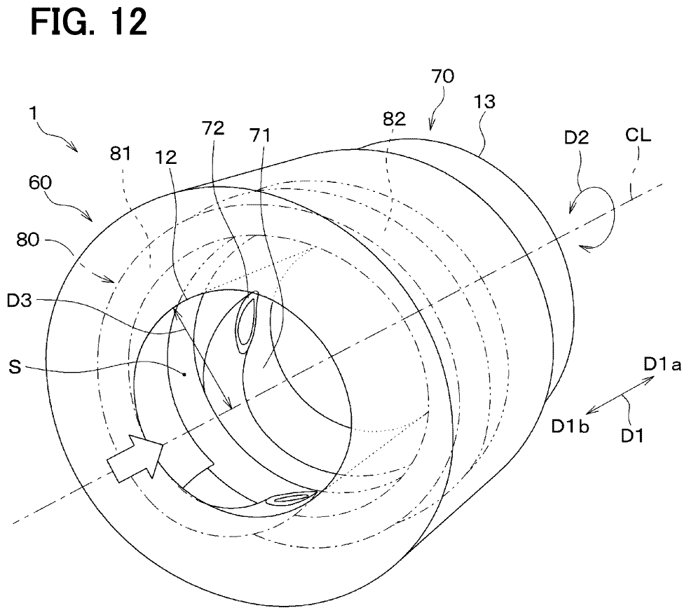

Next, a fourth embodiment will be described with reference to FIGS. 12 to 14. In the present embodiment, the configuration of the sound insulator 1 is different from that in the first embodiment. The other configurations are the same as those of the first embodiment. Therefore, in the present embodiment, portions different from the first embodiment will be mainly described, and description of portions similar to the first embodiment may be omitted.

The sound insulator 1 of the present embodiment is configured by combining two cylindrical members extending along a predetermined axial direction. Specifically, the sound insulator 1 has a first cylindrical portion 60 having a hollow cylindrical shape and a second cylindrical portion 70 disposed inside the first cylindrical portion 60. In the sound insulator 1, the second cylindrical portion 70 is fitted into the inside of the first cylindrical portion 60 from the transmission direction D1a side toward the reverse transmission direction D1b side. In the sound insulator 1, the first cylindrical portion 60 and the second cylindrical portion 70 each form a transmission space S, and sound waves can be introduced into the inner circumferential side of each transmission space S. Inside the sound insulator 1, a bypass pipe 80 (described later) is provided for bypassing a part of the sound waves introduced to the inner periphery side of each of the first cylindrical portion 60 and the second cylindrical portion 70. The first cylindrical portion 60 and the second cylindrical portion 70 correspond to space forming portions that form the transmission space S. Further, the first cylindrical portion 60 corresponds to a first forming portion that forms the transmission space S. The second cylindrical portion 70 corresponds to a second forming portion that forms the transmission space S.

The first cylindrical portion 60 and the second cylindrical portion 70 extend along the axial direction D1, and are formed to have the same size in the axial direction D1. The first cylindrical portion 60 has an outer diameter larger than that of the second cylindrical portion 70 and an inner diameter smaller than that of the second cylindrical portion 70. The first cylindrical portion 60 has a hollow shape with a surface on the transmission direction D1a side opening toward the reverse transmission direction D1b side in a bottomed cylindrical shape. The opening of this bottomed cylindrical portion has a shape corresponding to that of the second cylindrical portion 70. The first cylindrical portion 60 has an opening portion in the bottomed cylindrical shape into which the second cylindrical portion 70 can be inserted from the transmission direction D1a side. Furthermore, when the second cylindrical portion 70 is inserted, the first cylindrical portion 60 is capable of rotating in the circumferential direction D2 by an externally applied force.

The first cylindrical portion 60 has the introduction opening 12 for introducing sound waves into the transmission space S at the end on the reverse transmission direction D1b side. Furthermore, the first cylindrical portion 60 has a first bypass pipe 81, which is part of the bypass pipe 80 described later, provided inside, and an inlet opening 62 communicating with the bypass pipe 80 is formed on the first inner surface 61 on the inside in the radial direction D3. The first inner surface 61 forms the transmission space S through which sound waves are transmitted inside the first cylindrical portion 60. The first bypass pipe 81 and the inlet opening 62 will be described in detail later. In FIG. 12, the first bypass pipe 81 is indicated by a dashed line.

The second cylindrical portion 70 has an outer diameter smaller than that of the first cylindrical portion 60 and an inner diameter larger than that of the first cylindrical portion 60, and has a hollow shape with a bottomed cylindrical shape whose surface on the side facing the reverse transmission direction D1b is open toward the transmission direction D1a. The second cylindrical portion 70 also has the discharge opening 13 at the end on the transmission direction D1a side, which guides the sound waves introduced into the transmission space S to the outside. Furthermore, the second cylindrical portion 70 has a second bypass pipe 82 (described later) which is part of the bypass pipe 80 provided inside, and an outlet opening 72 communicating with the second bypass pipe 82 is formed on the second inner surface 71 on the inside in the radial direction D3. The second inner surface 71 forms the transmission space S through which sound waves are transmitted inside the second cylindrical portion 70. The outlet opening 72 is located farther away from the introduction opening 12 than the inlet opening 62. In addition, in FIG. 12, the second bypass pipe 82 is indicated by a two-dot chain line.

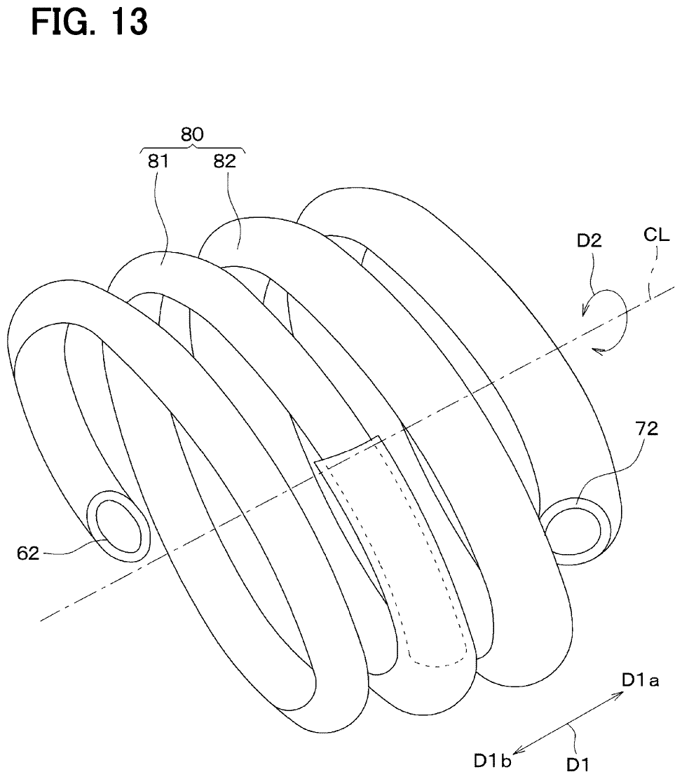

The first cylindrical portion 60 has a first bypass pipe 81 shown in FIGS. 12 and 13 into which a part of the sound waves introduced into the transmission space S from the introduction opening 12 is introduced. As shown in FIG. 13, the first bypass pipe 81 is arranged around the axis CL of the sound insulator 1 formed by combining the first cylindrical portion 60 and the second cylindrical portion 70, and is formed in a spiral shape extending in the axial direction D1. The first bypass pipe 81 is made of, for example, resin. The first bypass pipe 81 may be formed of a material other than resin, such as metal.

The first bypass pipe 81 has a constant outer diameter along the axial direction D1. Further, the first bypass pipe 81 has a constant pitch in the axial direction D1 each time it rotates in the circumferential direction D2 about the axis CL of the sound insulator 1. The first bypass pipe 81 has a hollow shape, and is capable of transmitting sound waves inside. That is, the first bypass pipe 81 has a tubular shape and forms a path through which sound waves are transmitted.

The first bypass pipe 81 has an end portion on the reverse transmission direction D1b side that communicates with the inlet opening 62. The first bypass pipe 81 on the transmission direction D1a side is inserted into the second bypass pipe 82. In addition, the first bypass pipe 81 is capable of rotating integrally with the first cylindrical portion 60 as the first cylindrical portion 60 rotates in the circumferential direction D2.

The second cylindrical portion 70 has a second bypass pipe 82 shown in FIG. 13 into which a part of the sound waves introduced into the transmission space S from the introduction opening 12 is introduced. As shown in FIG. 13, the second bypass pipe 82 is disposed around the axis CL of the sound insulator 1 and is formed in a spiral shape extending in the axial direction D1. The second bypass pipe 82 is formed of, for example, the same resin as the first bypass pipe 81. The second bypass pipe 82 may be formed, for example, from a material different from that of the first bypass pipe 81, or may be formed from a material other than resin, such as metal.

The second bypass pipe 82 has a constant outer diameter along the axial direction D1. Further, the second bypass pipe 82 has a constant pitch in the axial direction D1 each time it rotates in the circumferential direction D2 about the axis CL of the sound insulator 1. The pitch of the second cylindrical portion 70 is equal to the pitch of the first bypass pipe 81. The second bypass pipe 82 has a hollow shape, and is capable of transmitting sound waves inside. That is, the second bypass pipe 82 has a tubular shape and forms a path through which sound waves are transmitted.

The second bypass pipe 82 has an end portion on the transmission direction D1a side that communicates with the outlet opening 72. In the present embodiment, the second bypass pipe 82 has an inner diameter slightly larger than the outer diameter of the first bypass pipe 81, so that the first bypass pipe 81 can be inserted therein. In the present embodiment, the first bypass pipe 81 is inserted into the inside of the second bypass pipe 82 from the end of the second bypass pipe 82 on the reverse transmission direction D1b side, and the path formed by the first bypass pipe 81 is connected to the path formed by the second bypass pipe 82. The first bypass pipe 81 is inserted into the second bypass pipe 82 to form a bypass pipe 80 that bypasses a part of the sound waves introduced into the transmission space S. In FIG. 13, the portion of the first bypass pipe 81 that is inserted inside the second bypass pipe 82 is indicated by a dashed line.

The inlet opening 62 and the outlet opening 72 have their respective opening planes intersecting in the radial direction D3. In other words, the inlet opening 62 and the outlet opening 72 have their respective opening planes intersecting with the direction in which they extend radially with respect to the axis of the transfer space S. Specifically, the first inner surface 61 has a surface surrounding the inlet opening 62 that is either recessed or protruded with respect to other portions. The opening surface that defines the inlet opening 62 is inclined with respect to a straight line that extends from the axis CL toward the first inner surface 61 in the radial direction D3.

Further, the second inner surface 71 has a shape such that the surface surrounding the outlet opening 72 is either recessed or protruded with respect to other portions. The opening surface that defines the outlet opening 72 is inclined with respect to a straight line that extends in the radial direction D3 from the axis CL toward the second inner surface 71.

The directions in which the opening planes of the inlet opening 62 and the outlet opening 72 intersect with the radial direction D3 may be the same or different from each other. For example, the inlet opening 62 and the outlet opening 72 may intersect with the radial direction D3 so that their respective opening surfaces face toward the introduction opening 12 side, or may intersect with the radial direction D3 so that their respective opening surfaces face toward the discharge opening 13 side. Alternatively, the inlet opening 62 and the outlet opening 72 may intersect with the radial direction D3 so that their respective opening surfaces do not face either the introduction opening 12 or the discharge opening 13.

In addition, the bypass pipe 80 communicates with the transmission space S via the inlet opening 62 and the outlet opening 72. In addition, the inlet opening 62, which is formed at a position closer to the introduction opening 12 than the outlet opening 72, connects the transmission space S to the first bypass pipe 81, thereby guiding the sound waves introduced into the transmission space S to the first bypass pipe 81. The outlet opening 72 connects the second bypass pipe 82 to the transmission space S, thereby guiding the sound waves introduced into the second bypass pipe 82 via the inlet opening 62 and the first bypass pipe 81 to the transmission space S.

Therefore, the bypass pipe 80 enables part of the sound waves introduced into the transmission space S through the introduction opening 12 to be guided to the discharge opening 13 by bypassing part of the transmission space S, thereby enabling the sound waves to be guided outside the sound insulator 1. Specifically, the bypass pipe 80 forms a bypass path that bypasses a portion of the transmission space S by introducing a part of the sound waves introduced into the transmission space S through the inlet opening 62, passing the sound waves through the bypass pipe 80, and guiding the sound waves to the transmission space S through the outlet opening 72. The sound waves introduced into the bypass pipe 80 from the inlet opening 62 are transmitted in order through the first bypass pipe 81 and the second bypass pipe 82, and are guided to the outlet opening 72 and returned to the transmission space S.

Therefore, the intensity of the sound waves transmitted within the transmission space S is attenuated in a range corresponding to the frequency band of the sound waves returned to the transmission space S via the first bypass pipe 81 and the second bypass pipe 82. The bypass pipe 80 in the present embodiment corresponds to a phase adjustment portion that changes the phase of a portion of the sound waves introduced into the transmission space S.

In addition, the bypass pipe 80 is capable of increasing or decreasing the portion of the first bypass pipe 81 that is inserted inside the second bypass pipe 82 by rotating the first bypass pipe 81 together with the first cylindrical portion 60 in the circumferential direction D2. In other words, the relative position of the first bypass pipe 81 and the second bypass pipe 82 in the axial direction D1 changes as the first bypass pipe 81 rotates in the circumferential direction D2 together with the first cylindrical portion 60, thereby making it possible to increase or decrease the amount of insertion of the first bypass pipe 81 into the second bypass pipe 82.

Furthermore, by increasing or decreasing the insertion portion of the first bypass pipe 81 that is inserted inside the second bypass pipe 82, the transmission distance of the sound waves from the inlet opening 62 to the outlet opening 72 can be changed. In other words, the bypass pipe 80 is capable of changing the distance of the bypass path that bypasses the portion of the transmission space S by changing the relative position between the first bypass pipe 81 and the second bypass pipe 82 in the axial direction D1. Hereinafter, the length of the bypass pipe 80 from the inlet opening 62 to the outlet opening 72 in the present embodiment will be referred to as the bypass length.

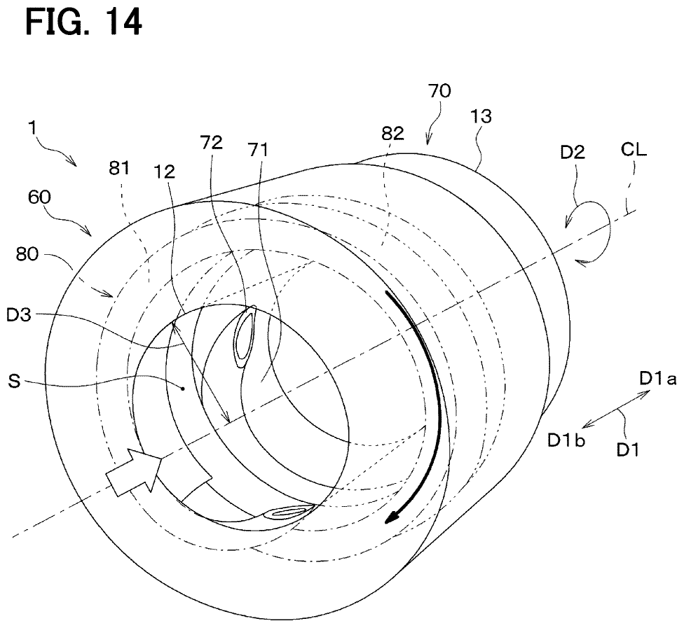

In the present embodiment, as shown by the arrow in FIG. 14, as the first cylindrical portion 60 rotates in the circumferential direction D2 and the insertion portion of the first bypass pipe 81 that is inserted inside the second bypass pipe 82 increases, the bypass length becomes smaller. In other words, the more the first cylindrical portion 60 rotates in the circumferential direction D2 so that the end of the first bypass pipe 81 on the transmission direction D1a side is inserted toward the end of the second bypass pipe 82 on the transmission direction D1a side, the smaller the bypass length becomes.

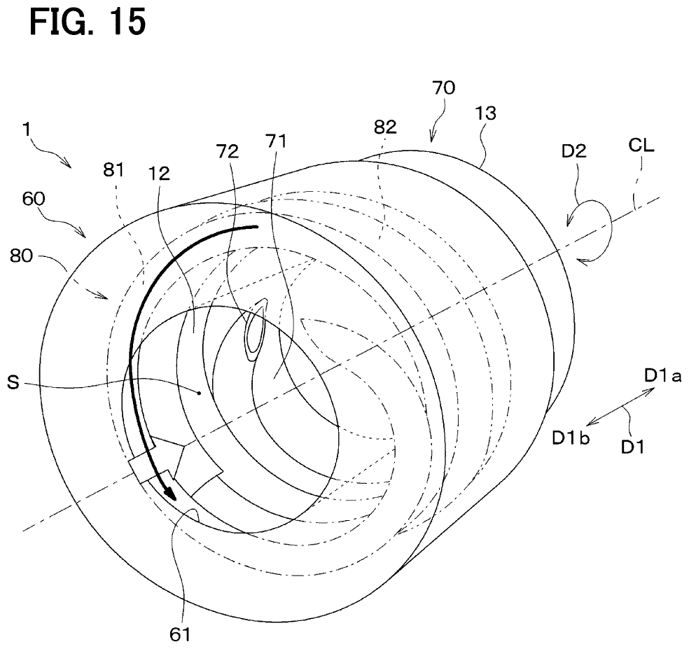

In contrast, as shown by the arrow in FIG. 15, as the first cylindrical portion 60 rotates and the insertion portion of the first bypass pipe 81 that is inserted into the second bypass pipe 82 decreases, the bypass length increases. In other words, the bypass length increases as the first cylindrical portion 60 rotates in the circumferential direction D2 so that the insertion portion of the first bypass pipe 81 on the transmission direction D1a side is gradually pulled out from the end of the second bypass pipe 82 on the reverse transmission direction D1b side.

Therefore, by rotating the first cylindrical portion 60 in the circumferential direction D2, the frequency band of sound that can be attenuated by the bypass pipe 80 can be changed. Specifically, by rotating the first cylindrical portion 60 to shorten the bypass length, it is possible to increase the frequency band of sound that corresponds to the bypass length among the frequency bands of sound that can be attenuated by the sound insulator 1. In contrast to this configuration, by rotating the first cylindrical portion 60 to lengthen the bypass length, it is possible to lower the frequency band of sounds that corresponds to the bypass length among the frequency bands of sound that can be attenuated by the sound insulator 1.

As described above, the sound insulator 1 has the first cylindrical portion 60 and the second cylindrical portion 70 each extending along the axial direction D1 to form the transmission space S. The bypass pipe 80 includes the first bypass pipe 81 having a hollow shape provided in the first cylindrical portion 60, and the second bypass pipe 82 having a hollow shape provided in the second cylindrical portion 70. The first bypass pipe 81 has one side communicating with the inlet opening 62, and the other side inserted into the second bypass pipe 82 and communicating with the second bypass pipe 82. The second bypass pipe 82 has one side communicating with the outlet opening 72, and the other side communicating with the first bypass pipe 81. The first bypass pipe 81 and the second bypass pipe 82 have their bypass lengths changed as the first cylindrical portion 60 rotates in the circumferential direction D2 to change the relative positions between the first cylindrical portion 60 and the second cylindrical portion 70 in the axial direction D1.

According to this configuration, the frequency band of sounds that can be attenuated can be changed by changing the relative positions between the first cylindrical portion 60 and the second cylindrical portion 70 in the axial direction D1. Therefore, sounds in various frequency bands that are output from the transmission space S to the outside through the discharge opening 13 can be attenuated.

### Modified Example of Fourth Embodiment

In the above-described fourth embodiment, an example has been described in which the first cylindrical portion 60 is rotatable in the circumferential direction D2 by a force applied from the outside, but the present disclosure is not limited to this configuration. For example, the second cylindrical portion 70 may be rotatable in the circumferential direction D2 by the force applied from the outside. In this case, the bypass pipe 80 may be configured so that the second bypass pipe 82 can be inserted inside the first bypass pipe 81.

### Fifth Embodiment

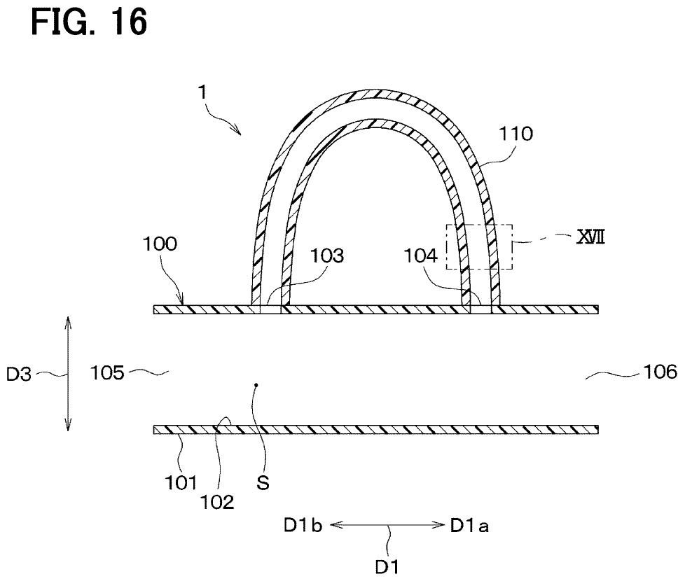

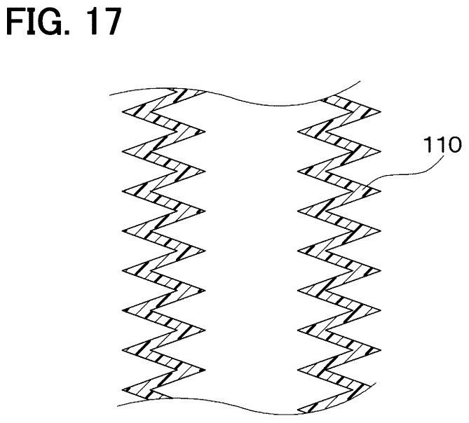

Next, a fifth embodiment will be described with reference to FIGS. 16 and 17. This embodiment differs from the first embodiment in that the inner cylindrical portion 10 and the outer cylindrical portion 20 are replaced with a tube portion 100, and the bypass groove 30 is replaced with a bypass portion 110. The other configurations are the same as those of the first embodiment. Therefore, in the present embodiment, portions different from the first embodiment will be mainly described, and description of portions similar to the first embodiment may be omitted.

As shown in FIG. 16, the sound insulator 1 of the present embodiment is composed of a single cylindrical tube portion 100 extending along a predetermined axial direction, and the bypass portion 110 provided outside the tube portion 100. The sound insulator 1 is capable of introducing sound waves to the inner peripheral side of the tube portion 100. In the present embodiment, the direction in which the tube portion 100 extends is defined as the axial direction D1, as in the first embodiment, and the direction in which the tube portion 100 extends radially from the axis of the tube portion 100 is defined as the radial direction D3, as in the first embodiment.

The tube portion 100 has, for example, a cylindrical shape, and has an outer peripheral surface 101 on the outer side in the radial direction D3, and an inner peripheral surface 102 on the inner side in the radial direction D3. A bypass portion 110 is connected to the outer peripheral surface 101. The inner peripheral surface 102 forms the transmission space S in the present embodiment. In addition, the tube portion 100 has an inlet 105 at its end on the reverse transmission direction D1b side for introducing sound waves into the transmission space S, and an outlet 106 at its end on the transmission direction D1a side for extracting the sound waves introduced into the transmission space S to the outside of the transmission space S. In the present embodiment, the tube portion 100 corresponds to the space forming portion, the inlet 105 corresponds to the introduction portion, and the outlet 106 corresponds to the discharge portion.

Furthermore, the tube portion 100 has two communication holes 103 and 104 that communicate with the bypass portion 110. One of the two communication holes 103, 104 is formed on the side of the reverse transmission direction D1b compared to the other. That is, one of the two communication holes 103, 104 is formed at a position closer to the inlet 105 than the other.

Hereinafter, of the two communication holes 103, 104, the one closer to the inlet 105 will be referred to as the inlet side communication hole 103, and the one farther from the inlet 105 will be referred to as the outlet side communication hole 104. The inlet side communication hole 103 in the present embodiment corresponds to an inlet portion that communicates the transmission space S with the bypass portion 110 and guides sound waves from the transmission space S to the bypass portion 110. In addition, the outlet side communication hole 104 in the present embodiment corresponds to an outlet portion that communicates the transmission space S with the bypass portion 110 and guides sound waves from the bypass portion 110 to the transmission space S. The inlet side communication hole 103 and the outlet side communication hole 104 are formed side by side in the axial direction D1 at a predetermined interval. The tube portion 100 may be formed, for example, in a rectangular cylindrical shape.

The bypass portion 110 has a hollow shape, and is capable of transmitting sound waves therethrough. Further, the bypass portion 110 of the present embodiment is extendable and contractible, and its length can be changed in response to the extension or contraction. Specifically, as shown in FIG. 17, the bypass portion 110 has a bellows structure with repeated projections and recesses on the outer periphery, and is extendable and contractible due to compressive and tensile forces. The bypass portion 110 is formed of, for example, an elastically deformable resin such as rubber. However, the material of the bypass portion 110 is not limited thereto, and the bypass portion 110 may be formed of a material other than rubber.

In addition, the bypass portion 110 is connected to the inlet side communication hole 103 on one side and to the outlet side communication hole 104 on the other side, and is connected to the transmission space S. Therefore, the bypass portion 110 forms a bypass path that guides a part of the sound waves introduced into the transmission space S from the inlet 105 to the outlet 106 by bypassing a portion of the transmission space S. Specifically, the bypass portion 110 introduces a part of the sound waves introduced into the transmission space S through the inlet side communication hole 103, and then passes the sound waves through the bypass portion 110 and out through the outlet side communication hole 104 to the transmission space S, thereby bypassing a portion of the transmission space S. The sound waves introduced from the inlet side communication hole 103 to the bypass portion 110 pass through the bypass portion 110 and are guided to the outlet side communication hole 104 and returned to the transmission space S.

Therefore, the sound waves transmitted within the transmission space S have their intensity attenuated, the intensity corresponding to the frequency band of the sound waves returned to the transmission space S via the bypass portion 110. The bypass portion 110 in the present embodiment corresponds to a phase adjustment portion that changes the phase of a part of the sound waves introduced into the transmission space S.

Moreover, the bypass portion 110 is extendable and contractible, and its length can be changed according to the extension or contraction. In the present embodiment, the length of the bypass portion 110 from the inlet side communication hole 103 to the outlet side communication hole 104 is referred to as the bypass length. The more the bypass portion 110 extends, the longer the bypass length becomes, and conversely, the more the bypass portion 110 shortens, the shorter the bypass length becomes.

Therefore, by expanding or contracting the bypass portion 110, the frequency band of sounds that can be attenuated by the bypass portion 110 can be changed. Specifically, by extending the bypass portion 110 and increasing the bypass length, it is possible to lower the frequency band of sounds that corresponds to the bypass length among the frequency bands of sounds that the sound insulator 1 can attenuate. In contrast, by shortening the bypass portion 110 and shortening the bypass length, it is possible to increase the frequency band of sounds that correspond to the bypass length among the frequency bands of sounds that the sound insulator 1 can attenuate. Therefore, sounds in various frequency bands that are output from the transmission space S to the outside through the outlet 106 can be attenuated.

### Sixth Embodiment

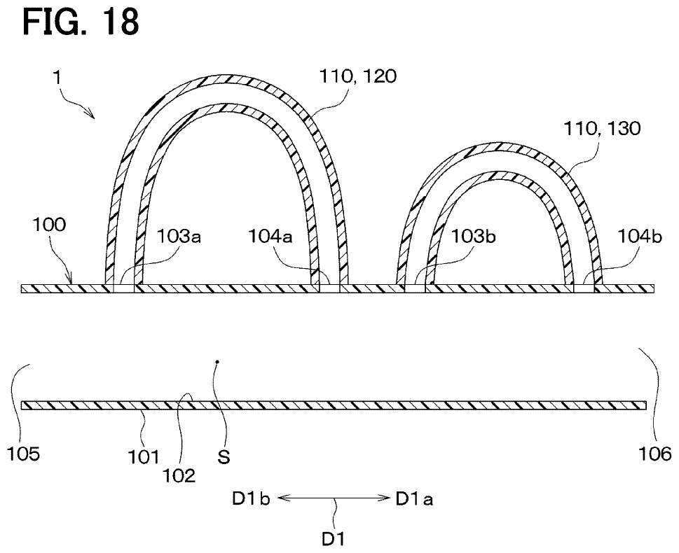

Next, a sixth embodiment will be described with reference to FIG. 18. In the present embodiment, the configuration of the bypass portion 110 is different from that of the fifth embodiment. The other configuration is the same as that of the fifth embodiment. Therefore, in the present embodiment, portions different from the fifth embodiment will be mainly described, and description of portions similar to the fifth embodiment may be omitted.

The sound insulator 1 of the present embodiment has two bypass portions 110 as shown in FIG. 18. These two bypass portions 110 are connected to each other at different positions on the outer peripheral surface 101 of the tube portion 100 and are disposed apart from each other. Specifically, of the two bypass portions 110, one bypass portion 110 is formed at a position closer to the inlet 105 than the other bypass portion 110.

Hereinafter, of the two bypass portions 110, the one closer to the inlet 105 is referred to as a first bypass portion 120, and the one farther from the inlet 105 is referred to as a second bypass portion 130. The first bypass portion 120 and the second bypass portion 130 are formed side by side in the axial direction D1 with a predetermined gap therebetween. In addition, although not shown, the first bypass portion 120 and the second bypass portion 130 are expandable and contractible by a bellows structure with repeated projections and recesses on the outer periphery, similar to the fifth embodiment, and the length can be changed depending on the expansion and contraction.

The tube portion 100 has a first inlet side communication hole 103a and a first outlet side communication hole 104a that communicate with the first bypass portion 120, and a second inlet side communication hole 103b and a second outlet side communication hole 104b that communicate with the second bypass portion 130. The first inlet side communication hole 103a is formed on the reverse transmission direction D1b side compared to the first outlet side communication hole 104a, the second inlet side communication hole 103b, and the second outlet side communication hole 104b. That is, the first inlet side communication hole 103a is formed at a position closer to the inlet 105 than the first outlet side communication hole 104a, the second inlet side communication hole 103b, and the second outlet side communication hole 104b. The first inlet side communication hole 103a is an inlet portion for guiding sound waves to the first bypass portion 120. The first outlet side communication hole 104a is an outlet for guiding the sound waves introduced into the first bypass portion 120 to the transmission space S.

The second inlet side communication hole 103b is formed on the reverse transmission direction D1b side compared to the second outlet side communication hole 104b. That is, the second inlet side communication hole 103b is formed at a position closer to the inlet 105 than the second outlet side communication hole 104b. The second inlet side communication hole 103b is an inlet portion for guiding sound waves to the second bypass portion 130. The second outlet side communication hole 104b is an outlet for guiding the sound waves introduced into the second bypass portion 130 to the transmission space S. In the present embodiment, the tube portion 100 has the same number of inlet portions and outlet portions.

The first bypass portion 120 of the present embodiment formed in this manner communicates with the transmission space S via the first inlet side communication hole 103a and the first outlet side communication hole 104a. Therefore, the first bypass portion 120 forms a bypass that guides a part of the sound waves introduced into the transmission space S to the outlet 106 by bypassing a portion of the transmission space S. Then, the sound waves introduced from the first inlet side communication hole 103a to the first bypass portion 120 pass through the first bypass portion 120 and are guided to the first outlet side communication hole 104a and returned to the transmission space S.

In addition, the second bypass portion 130 of the present embodiment communicates with the transmission space S via the second inlet side communication hole 103b and the second outlet side communication hole 104b. Therefore, the second bypass portion 130 forms a bypass that guides a part of the sound waves introduced into the transmission space S to the outlet 106 by bypassing a portion of the transmission space S. The sound waves introduced from the second inlet side communication hole 103b to the second bypass portion 130 pass through the second bypass portion 130 and are guided to the second outlet side communication hole 104b and returned to the transmission space S.

As a result, the sound waves transmitted within the transmission space S are attenuated in intensity corresponding to the frequency band of the sound waves returned to the transmission space S via the first bypass portion 120, and in intensity corresponding to the frequency band of the sound waves returned to the transmission space S via the second bypass portion 130. In addition, the first bypass portion 120 is extendable and contractible, so that the length from the first inlet side communication hole 103a to the first outlet side communication hole 104a can be changed. In addition, the second bypass portion 130 is extendable and contractible, so that the length from the second inlet side communication hole 103b to the second outlet side communication hole 104b can be changed.

Hereinafter, the length of the first bypass portion 120 from the first inlet side communication hole 103a to the first outlet side communication hole 104a will be referred to as a first bypass length. The length of the second bypass portion 130 from the second inlet side communication hole 103b to the second outlet side communication hole 104b is referred to as a second bypass length. The first bypass portion 120 and the second bypass portion 130 are configured such that the first bypass length and the second bypass length can be different from each other. For example, the first bypass portion 120 and the second bypass portion 130 are formed so that the first bypass length when the first bypass length is at its maximum is different from the second bypass length when the second bypass length is at its maximum.

Therefore, by expanding or contracting the first bypass portion 120, the frequency band of sound that can be attenuated by the first bypass portion 120 can be changed. Specifically, by extending the first bypass portion 120 and lengthening the first bypass length, it is possible to lower the frequency band of sound that corresponds to the first bypass length among the frequency bands of sound that can be attenuated by the sound insulator 1. Furthermore, by extending the second bypass portion 130 and lengthening the second bypass length, it is possible to lower the frequency band of sounds that corresponds to the second bypass length among the frequency bands of sounds that the sound insulator 1 can attenuate.

In contrast to this configuration, by shortening the first bypass portion 120 and shortening the first bypass length, it is possible to increase the frequency band of sound that corresponds to the first bypass length among the frequency bands of sound that can be attenuated by the sound insulator 1. Furthermore, by shortening the second bypass portion 130 and shortening the second bypass length, the frequency band of sound that can be attenuated by the sound insulator 1 can be increased in the frequency band that corresponds to the second bypass length.

According to this configuration, the sound insulator 1 can reduce the frequency band of sound corresponding to the first bypass length, and attenuate the frequency band of sound corresponding to the second bypass length. Therefore, sounds in various frequency bands that are output from the transmission space S to the outside through the outlet 106 can be attenuated.

### Seventh Embodiment

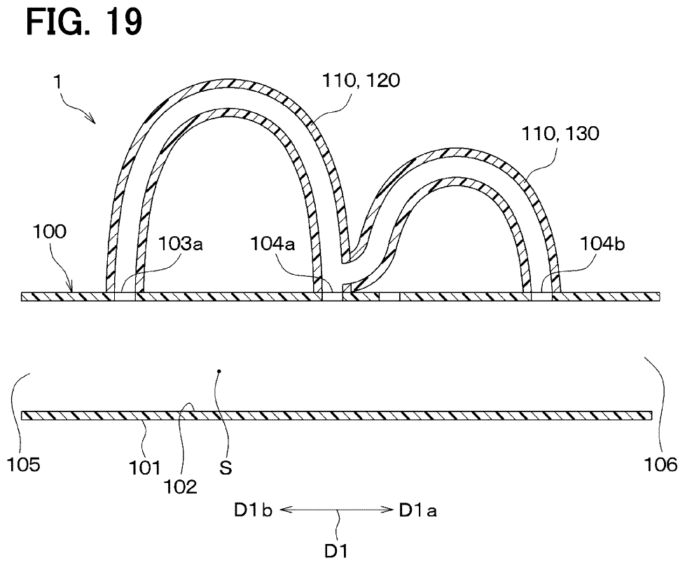

Next, a seventh embodiment will be described with reference to FIG. 19. In the present embodiment, the configuration of the second bypass portion 130 is different from that of the sixth embodiment. The other configuration is the same as that of the sixth embodiment. Therefore, in the present embodiment, portions different from the sixth embodiment will be mainly described, and description of portions similar to the sixth embodiment may be omitted.

The second bypass portion 130 of the present embodiment is connected to the first bypass portion 120 as shown in FIG. 19. That is, of the first bypass portion 120 and the second bypass portion 130, the second bypass portion 130 which is farther from the inlet 105 is connected to the first bypass portion 120 which is closer to the inlet 105. The second bypass portion 130 has an end closer to the inlet 105 connected to a portion of the bypass path formed by the first bypass portion 120 that is closer to the outlet 106. Therefore, in the tube portion 100 of the present embodiment, the second inlet side communication hole 103b for guiding sound waves to the second bypass portion 130 is not formed, as compared to the sixth embodiment. That is, the tube portion 100 of the present embodiment is formed with three holes: a first inlet side communication hole 103a, a first outlet side communication hole 104a, and a second outlet side communication hole 104b. Therefore, the tube portion 100 of the present embodiment has a different number of inlet portions and a different number of outlet portions. Specifically, the number of inlet portions is less than the number of outlet portions.

The first bypass portion 120 of the present embodiment formed in this manner communicates with the transmission space S via the first inlet side communication hole 103a and the first outlet side communication hole 104a. Therefore, the first bypass portion 120 enables a part of the sound waves introduced into the transmission space S to be guided to the outside of the sound insulator 1 by bypassing a portion of the transmission space S.

In addition, the second bypass portion 130 of the present embodiment is in communication with the transmission space S via the first bypass portion 120 and the second outlet side communication hole 104b. Therefore, the second bypass portion 130 enables a part of the sound waves introduced into the transmission space S to be guided to the outside of the sound insulator 1 by bypassing a portion of the transmission space S. The first bypass portion 120 and the second bypass portion 130 are capable of changing the bypass length. Hereinafter, in the present embodiment, the length from the first inlet side communication hole 103a to the point where the second bypass portion 130 is connected plus the length from the point where the first bypass portion 120 is connected to the second outlet side communication hole 104b will be referred to as the second bypass length. In addition, the first bypass portion 120 and the second bypass portion 130 in the present embodiment are configured such that the length of the first bypass portion 120 and the length of the second bypass portion 130 can be different from each other, similar to the sixth embodiment.

The sound waves introduced from the first inlet side communication hole 103a to the first bypass portion 120 pass through the first bypass portion 120 and are guided to the first outlet side communication hole 104a and returned to the transmission space S. In addition, the sound waves introduced from the first bypass portion 120 to the second bypass portion 130 pass through the second bypass portion 130 and are guided to the second outlet side communication hole 104b and returned to the transmission space S. Therefore, the intensity of the sound waves transmitted within the transmission space S is attenuated in a frequency band corresponding to the sound waves returned to the transmission space S via the first bypass portion 120. Furthermore, the sound waves transmitted within the transmission space S have their intensity attenuated in a range corresponding to the frequency band of the sound waves returned to the transmission space S via the first bypass portion 120 and the second bypass portion 130.

Therefore, by expanding or contracting the first bypass portion 120, the frequency band of sound that can be attenuated by the first bypass portion 120 and the second bypass portion 130 can be changed. Specifically, by extending the first bypass portion 120 and lengthening the first bypass length, it is possible to lower the frequency band of sound that corresponds to the first bypass length among the frequency bands of sound that can be attenuated by the sound insulator 1. Furthermore, by lengthening the first bypass length, it is possible to lower the frequency band of sounds that corresponds to the second bypass length, among the frequency bands of sounds that can be attenuated by the sound insulator 1. Furthermore, by extending the second bypass portion 130 and lengthening the second bypass length, it is possible to lower the frequency band of sounds that corresponds to the second bypass length among the frequency bands of sounds that the sound insulator 1 can attenuate.

In contrast to this configuration, by shortening the first bypass portion 120 and shortening the first bypass length, it is possible to increase the frequency band of sound that corresponds to the first bypass length among the frequency bands of sound that can be attenuated by the sound insulator 1. Furthermore, by lengthening the first bypass length, it is possible to raise the frequency band of sounds that corresponds to the second bypass length, among the frequency bands of sounds that can be attenuated by the sound insulator 1. Furthermore, by shortening the second bypass portion 130 and shortening the second bypass length, the frequency band of sound that can be attenuated by the sound insulator 1 can be increased in the frequency band that corresponds to the second bypass length.

Therefore, sounds in various frequency bands that are output from the transmission space S to the outside through the outlet 106 can be attenuated. Furthermore, by connecting the second bypass portion 130 to the first bypass portion 120, a configuration that does not include the second inlet side communication hole 103b can be achieved, as compared to the sixth embodiment. Therefore, the size of the tube portion 100 in the axial direction D1 can be easily reduced.

### First Modification of Seventh Embodiment

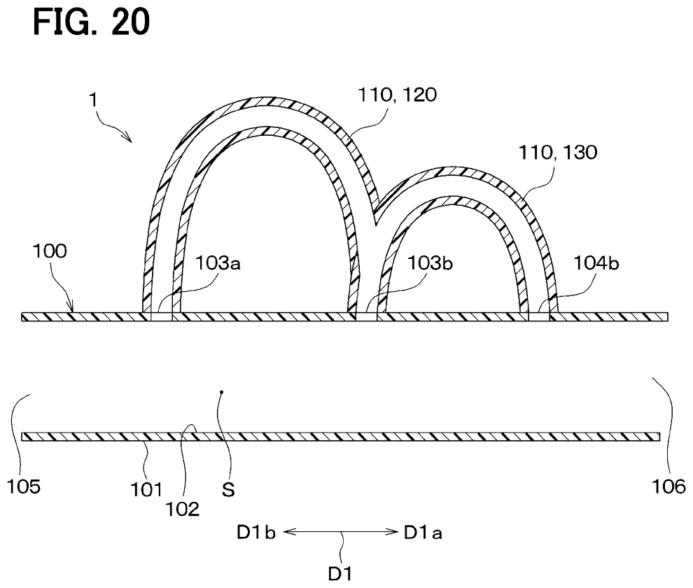

In the above-mentioned seventh embodiment, an example was described in which the second bypass portion 130 is connected to the first bypass portion 120, and the first inlet side communication hole 103a, the first outlet side communication hole 104a and the second outlet side communication hole 104b are formed in the tube portion 100, and the second inlet side communication hole 103b is not formed, but the present disclosure is not limited to this configuration. For example, the first bypass portion 120 may be connected to the second bypass portion 130. In this case, as shown in FIG. 20, the end of the first bypass portion 120 farther from the inlet 105 may be connected to a portion of the bypass path formed by the second bypass portion 130 that is closer to the inlet 105. The tube portion 100 may be configured to have three holes formed therein: a first inlet side communication hole 103a, a second inlet side communication hole 103b, and a second outlet side communication hole 104b. In this case, the tube portion 100 will have a different number of inlet portions and a different number of outlet portions, specifically, the number of inlet portions will be greater than the number of outlet portions.

### Second Modification of Seventh Embodiment

In the seventh embodiment described above, an example is described in which the first bypass portion 120 and the second bypass portion 130 are configured to have different lengths from each other, but the present disclosure is not limited to this configuration. For example, the first bypass portion 120 and the second bypass portion 130 may be configured to have the same length.

### Eighth Embodiment

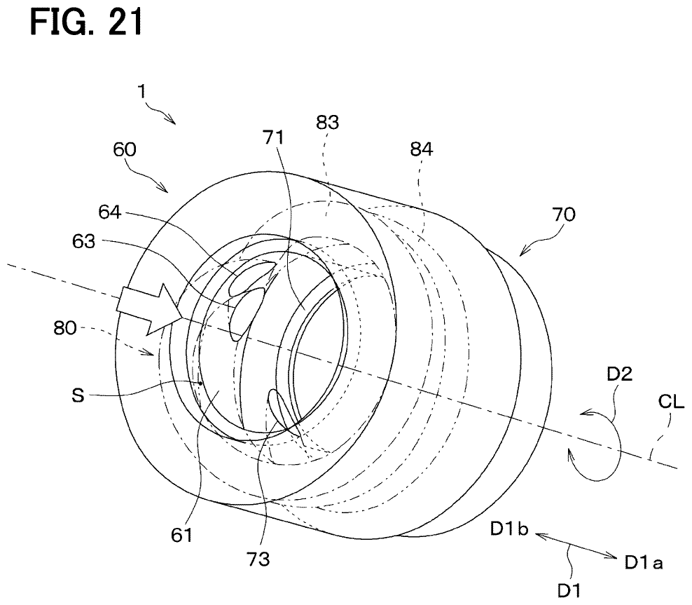

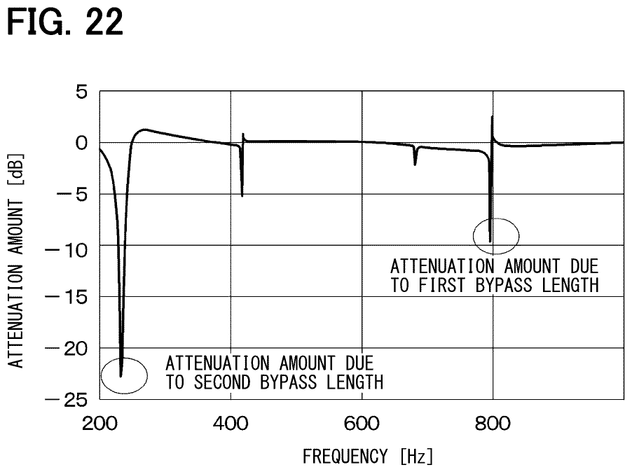

Next, an eighth embodiment will be described with reference to FIGS. 21 and 22. In the present embodiment, the configuration of the bypass portion 110 is different from that of the seventh embodiment. However, the configuration of the bypass portion 110 of the present embodiment is similar to the structure of the bypass pipe 80 described in the fourth embodiment. Other than this configuration, the present embodiment is the same as the fourth embodiment and the seventh embodiment. Therefore, in the present embodiment, the portions different from the fourth and seventh embodiments will be mainly described, and description of portions similar to the fourth and seventh embodiments may be omitted.

The sound insulator 1 of the present embodiment is configured by fitting a second cylindrical portion 70 inside a first cylindrical portion 60, similarly to the fourth embodiment. In the sound insulator 1, a part of the bypass pipe 80 is provided inside each of the first cylindrical portion 60 and the second cylindrical portion 70. As shown in FIG. 21, the portion of the bypass pipe 80 that is provided inside the first cylindrical portion 60 in the present embodiment is referred to as a first spiral pipe 83, and the portion of the bypass pipe 80 that is provided inside the second cylindrical portion 70 is referred to as a second spiral pipe 84.

Similar to the fourth embodiment, the first spiral pipe 83 and the second spiral pipe 84 are arranged around the axis CL of the sound insulator 1 and are formed in a spiral shape extending in the axial direction D1. The first spiral pipe 83 is inserted into the second spiral pipe 84 to form the bypass pipe 80. The second spiral pipe 84 in the present embodiment is inserted into the first spiral pipe 83 from a midway point and connected thereto. In addition, the bypass pipe 80 is capable of increasing or decreasing the portion of the first spiral pipe 83 that is inserted inside the second spiral pipe 84 by rotating the first spiral pipe 83 integrally with the first cylindrical portion 60 in the circumferential direction D2.

In addition, the first cylindrical portion 60 in the present embodiment has a common inlet opening 63 and a first outlet opening 64 formed on the first inner surface 61. The common inlet opening 63 corresponds to the first inlet side communication hole 103a in the seventh embodiment, and guides the sound waves introduced into the transmission space S to the first spiral pipe 83 and the second spiral pipe 84. The first outlet opening 64 corresponds to the first outlet side communication hole 104a in the seventh embodiment, and guides the sound waves introduced into the first spiral pipe 83 to the transmission space S.

Further, the second cylindrical portion 70 in the present embodiment has a second outlet opening 73 formed on the second inner surface 71. The second outlet opening 73 corresponds to the second outlet side communication hole 104b in the seventh embodiment, and guides the sound waves introduced into the second spiral pipe 84 via the first spiral pipe 83 to the transmission space S. The common inlet opening 63 is an inlet for guiding sound waves to the first spiral pipe 83 and the second spiral pipe 84. The first outlet opening 64 is an outlet for guiding the sound waves introduced into the first spiral pipe 83 to the transmission space S. The second outlet opening 73 is an outlet for guiding the sound waves introduced into the second spiral pipe 84 to the transmission space S.

Therefore, in the present embodiment, the sound waves introduced into the first spiral pipe 83 from the common inlet opening 63 pass through the first spiral pipe 83 and are guided to the first outlet opening 64 and returned to the transmission space S. In addition, the sound waves introduced from the first spiral pipe 83 to the second spiral pipe 84 pass through the second spiral pipe 84 and are guided to the second outlet opening 73 and returned to the transmission space S. Hereinafter, in the present embodiment, the length of the first spiral pipe 83 from the common inlet opening 63 to the first outlet opening 64 will be referred to as a first bypass length. In addition, the length from the common inlet opening 63 to the point where the second spiral pipe 84 is connected plus the length from the point where the second spiral pipe 84 is connected to the second outlet opening 73 is referred to as a second bypass length.

As shown in FIG. 22, in the sound waves transmitted within the transmission space S, the intensity of the sound waves corresponding to the frequency band of the sound waves returned to the transmission space S via the first spiral pipe 83 is attenuated. Furthermore, in the sound waves transmitted within the transmission space S, the intensity of the sound waves corresponding to the frequency band of the sound waves returned to the transmission space S via the first spiral pipe 83 and the second spiral pipe 84 is attenuated. In FIG. 22, among the attenuated sound waves, the higher frequency side indicates the intensity of the sound waves attenuated by the sound waves being transmitted through the first spiral pipe 83, and the lower frequency side indicates the intensity of the sound waves attenuated by the sound waves being transmitted through the second spiral pipe 84. The reason why the frequency of the sound waves attenuated by being transmitted through the first spiral pipe 83 is high is because the second bypass length is longer than the first bypass length.

In addition, the bypass pipe 80 is capable of increasing or decreasing the portion of the first spiral pipe 83 that is inserted inside the second spiral pipe 84 by rotating the first spiral pipe 83 integrally with the first cylindrical portion 60 in the circumferential direction D2.

Therefore, by rotating the first cylindrical portion 60 in the circumferential direction D2, the frequency band of sound that can be attenuated by the bypass pipe 80 can be changed. Specifically, by rotating the first cylindrical portion 60 to lengthen the first bypass length, it is possible to lower the frequency band of sound that corresponds to the first bypass length among the frequency bands of sound that can be attenuated by the sound insulator 1. Furthermore, by lengthening the first bypass length, it is possible to lower the frequency band of sounds that corresponds to the second bypass length, among the frequency bands of sounds that can be attenuated by the sound insulator 1.

In contrast to this configuration, by rotating the first cylindrical portion 60 to shorten the first bypass length, it is possible to increase the frequency band of sound that corresponds to the first bypass length among the frequency bands of sound that can be attenuated by the sound insulator 1. Furthermore, by lengthening the first bypass length, it is possible to raise the frequency band of sounds that corresponds to the second bypass length, among the frequency bands of sounds that can be attenuated by the sound insulator 1.

According to this configuration, the sound insulator 1 can reduce the frequency band of sound corresponding to the first bypass length, and attenuate the frequency band of sound corresponding to the second bypass length. Therefore, sounds of various frequency bands that are emitted from the transmission space S to the outside can be attenuated.

### Ninth Embodiment

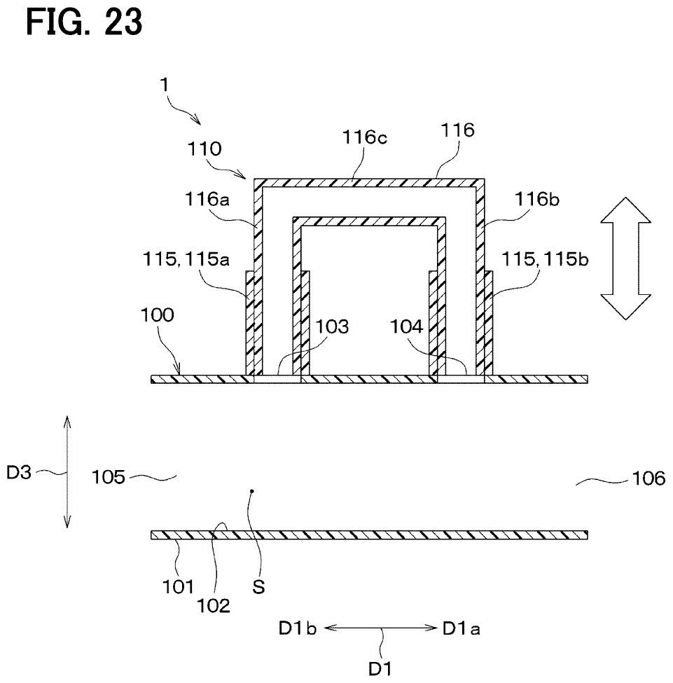

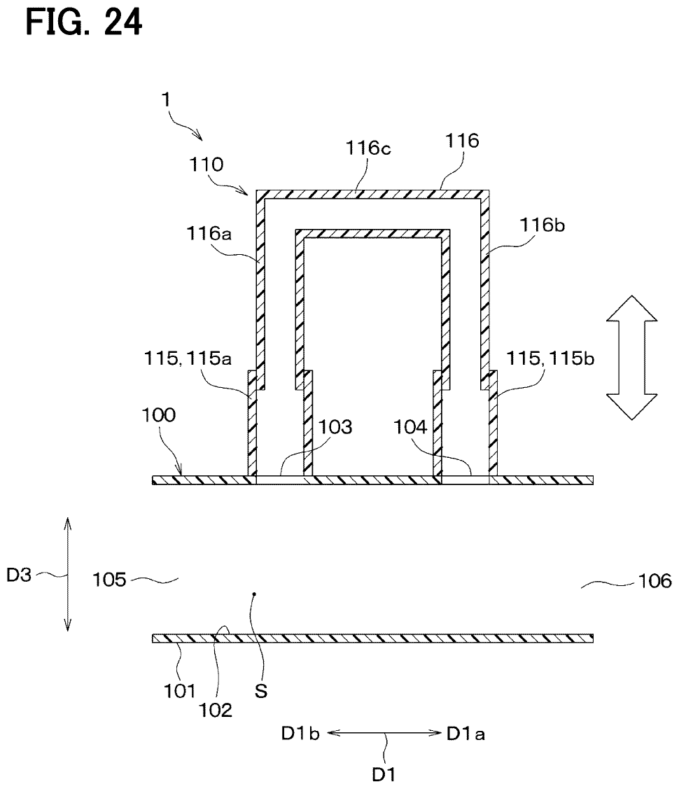

Next, a ninth embodiment will be described with reference to FIGS. 23 and 24. In the present embodiment, the configuration of the bypass portion 110 is different from that of the fifth embodiment. The other configuration is the same as that of the fifth embodiment. Therefore, in the present embodiment, portions different from the fifth embodiment will be mainly described, and description of portions similar to the fifth embodiment may be omitted.

As shown in FIG. 23, the bypass portion 110 of the present embodiment is composed of two bypass connecting parts 115 connected to the tube portion 100, and a bypass forming part 116 communicating with these two bypass connecting parts 115. The bypass portion 110, which is composed of the bypass connecting part 115 and the bypass forming part 116, forms a bypass path that causes a part of the sound waves introduced into the transmission space S from the inlet 105 to bypass the transmission space S and return to the transmission space S. The bypass connecting part 115 and the bypass forming part 116 are hollow and allow sound waves to transmit through the inside.

One of the two bypass connecting parts 115 is provided at a portion of the tube portion 100 where the inlet side communication hole 103 is formed, and communicates with the transmission space S. The other of the two bypass connecting parts 115 is provided in the portion of the tube portion 100 where the outlet side communication hole 104 is formed, and communicates with the transmission space S. Further, the two bypass connecting parts 115 are formed in a cylindrical shape protruding outward in the radial direction D3 from the portion connected to the tube portion 100. The bypass forming part 116 is inserted inside the two bypass connecting parts 115. Hereinafter, of the two bypass connecting parts 115, the one communicating with the inlet side communication hole 103 will be referred to as the inlet side connecting part 115a, and the one communicating with the outlet side communication hole 104 will be referred to as the outlet side connecting part 115b.

The bypass forming part 116 is formed in a U-shaped tube, with one end inserted into the inlet side connecting part 115a and the other end inserted into the outlet side connecting part 115b. The bypass forming part 116 communicates with the transmission space S via the inlet side connecting part 115a and the outlet side connecting part 115b. The bypass forming part 116 has an inlet side inserting part 116a that is inserted into the inlet side connecting part 115a, an outlet side inserting part 116b that is inserted into the outlet side connecting part 115b, and an insertion connecting part 116c that connects the inlet side inserting part 116a and the outlet side inserting part 116b.

The inlet side inserting part 116a is formed so that its outer diameter is smaller than the inner diameter of the inlet side connecting part 115a, and is capable of being inserted into the inlet side connecting part 115a. Further, the inlet side connecting part 115a is formed in a cylindrical shape extending along the radial direction D3, and is capable of transmitting sound waves transmitted from the inlet side connecting part 115a. The insertion connecting part 116c is formed in a cylindrical shape extending along the axial direction D1, with one end connected to the inlet side inserting part 116a and the other end connected to the outlet side inserting part 116b. The insertion connecting part 116c is capable of transmitting sound waves transmitted from the inlet side inserting part 116a to the outlet side inserting part 116b. The outlet side inserting part 116b is formed so that its outer diameter is smaller than the inner diameter of the outlet side connecting part 115b, and is capable of being inserted into the outlet side connecting part 115b. The outlet side connecting part 115b is formed in a cylindrical shape extending along the radial direction D3, and is capable of transmitting sound waves transmitted from the insertion connecting part 116c to the outlet side connecting part 115b.

Therefore, the bypass portion 110, which is composed of the bypass connecting part 115 and the bypass forming part 116, enables a part of the sound waves introduced into the transmission space S to be guided to the outside of the sound insulator 1 by bypassing a portion of the transmission space S. The sound waves introduced from the inlet side communication hole 103 to the bypass portion 110 pass through the bypass portion 110 and are guided to the outlet side communication hole 104 and returned to the transmission space S. Therefore, the sound waves transmitted within the transmission space S have their intensity attenuated, the intensity corresponding to the frequency band of the sound waves returned to the transmission space S via the bypass portion 110.

Further, the bypass forming part 116 in the present embodiment is movable along the direction in which the inlet side connecting part 115a and the outlet side connecting part 115b extend. Specifically, as shown in FIGS. 23 and 24, the bypass forming part 116 can move in the radial direction D3 to increase or decrease the portion where the inlet side inserting part 116a is inserted into the inlet side connecting part 115a, and can increase or decrease the portion where the outlet side inserting part 116b is inserted into the outlet side connecting part 115b. In other words, by moving the bypass forming part 116 in the radial direction D3, the amount inserted into the inlet side connecting part 115a at the inlet side inserting part 116a and the amount inserted into the outlet side connecting part 115b at the outlet side inserting part 116b can be increased or decreased.

Furthermore, by increasing or decreasing the portion of the inlet side inserting part 116a that is inserted into the inlet side connecting part 115a and the portion of the outlet side inserting part 116b that is inserted into the outlet side connecting part 115b, the bypass length in the present embodiment from the inlet side communication hole 103 to the outlet side communication hole 104 can be changed. In other words, the bypass portion 110 is capable of changing the distance of the bypass path by changing the distance from the inlet side communication hole 103 to the inlet side inserting part 116a and the distance from the outlet side communication hole 104 to the outlet side inserting part 116b.

In the present embodiment, as shown in FIG. 23, as the bypass forming part 116 moves outward in the radial direction D3, the bypass length becomes smaller as the portion inserted into the inlet side connecting part 115a at the inlet side inserting part 116a and the portion inserted into the outlet side connecting part 115b at the outlet side inserting part 116b increase. In contrast to this configuration, as shown in FIG. 24, as the bypass forming part 116 moves radially inward in the radial direction D3, the bypass length increases as the portion of the inlet side inserting part 116a that is inserted into the inlet side connecting part 115a and the portion of the outlet side inserting part 116b that is inserted into the outlet side connecting part 115b decrease.

Therefore, by moving the bypass forming part 116 in the radial direction D3, the frequency band of sound that can be attenuated by the bypass portion 110 can be changed. Specifically, by moving the bypass forming part 116 to shorten the bypass length, it is possible to increase the frequency band of sounds that correspond to the bypass length among the frequency bands of sounds that can be attenuated by the sound insulator 1. In contrast to this configuration, by moving the bypass forming part 116 to lengthen the bypass length, it is possible to lower the frequency band of sounds that corresponds to the bypass length among the frequency bands of sounds that the sound insulator 1 can attenuate.

This makes it possible to change the frequency band of sound waves that can be attenuated by the bypass portion 110, thereby making it possible to attenuate sound waves of various frequency bands among the sound waves that are guided to the outside from the transmission space S through the outlet 106.

### Other Embodiments

The representative embodiments of the present disclosure have been described above. However, the present disclosure is not limited to the above-described embodiments, and may be variously modified as follows.

In the above embodiment, an example has been described in which the sound insulator 1 is applied to a vehicle and attached to a vehicle part that generates noise, such as an electric compressor, but the present disclosure is not limited to this configuration. The sound insulator 1 can be applied to various things other than vehicles.

In the above-mentioned fourth embodiment, an example was described in which the bypass pipe 80 is composed of a spiral first bypass pipe 81 provided inside the first cylindrical portion 60 and a spiral second bypass pipe 82 provided inside the second cylindrical portion 70, but the present disclosure is not limited to this configuration. For example, the bypass pipe 80 may be configured such that two tubular members formed in a straight line are provided inside the first cylindrical portion 60 and the second cylindrical portion 70. In this case, one side of the two tubular members may be inserted inside the other side, and the insertion amount may be changed by moving the first cylindrical portion 60 and the second cylindrical portion 70 in the axial direction D1.

In the above-mentioned fourth to seventh and ninth embodiments, examples have been described in which the tube portion 100 extends along a predetermined axial direction and the bypass portion 110 is provided outside the tube portion 100, but the present disclosure is not limited to this configuration. For example, the tube portion 100 may be formed so that a part of the tube portion 100 is bent rather than being aligned along the axial direction.

In the above-mentioned fourth embodiment, an example was described in which the opening surfaces of the inlet opening 62 that guides sound waves from the transmission space S to the bypass path and the outlet opening 72 that guides sound waves from the bypass path to the transmission space S intersect in the radial direction D3. In the first to third, fifth to seventh, and ninth embodiments, the opening surfaces of the inlet side through hole 141, the inlet side communication hole 103, and the common inlet opening 63 corresponding to the inlet opening 62 may intersect in the radial direction D3. Also, in the first to third, fifth to seventh, and ninth embodiments, the opening surfaces of the outlet side through hole 142, the outlet side communication hole 104, the first outlet opening 64, and the second outlet opening 73 corresponding to the outlet opening 72 may intersect in the radial direction D3.

In the embodiments described above, it is needless to say that the elements configuring the embodiments are not necessarily essential except in the case where those elements are clearly indicated to be essential in particular, the case where those elements are considered to be obviously essential in principle, and the like.

In the embodiments described above, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments described above, when referring to the shape, positional relationship, and the like of a component and the like, it is not limited to the shape, positional relationship, and the like, except for the case where it is specifically specified, the case where it is fundamentally limited to a specific shape, positional relationship, and the like, and the like.

What is claimed is:

1. A sound insulator, comprising:
a space forming portion that forms a transmission space configured to transmit sound waves and has an introduction portion configured to introduce the sound waves into the transmission space and a discharge portion configured to discharge the sound waves introduced into the transmission space to an outside of the transmission space; and
a phase adjustment portion that attenuates the sound waves corresponding to a frequency of the sound waves whose phase is changed among the sound waves transmitted through the transmission space by changing the phase of a part of the sound waves transmitted through the transmission space, wherein
the phase adjustment portion changes a frequency band of the sound waves whose phase is changed.

2. The sound insulator according to claim 1, further comprising,
a bypass path configured to bypass a part of the sound waves introduced from the introduction portion into the transmission space and guide the part of the sound waves to the discharge portion, wherein
the space forming portion has an inlet that communicates the transmission space with the bypass path and guides the sound waves from the transmission space to the bypass path, and an outlet that communicates the transmission space with the bypass path and guides the sound waves from the bypass path to the transmission space,
when a length of the bypass path from the inlet to the outlet is defined as a bypass length, the bypass length is changeable, and
the phase adjustment portion is constituted by the bypass path.

3. The sound insulator according to claim 2, wherein
the bypass path changes the phase of the sound waves that passes through the bypass path and is transmitted to the outlet so that the phase of the sound waves that passes through the bypass path approaches an inverse phase of the phase of the sound waves that is transmitted to the outlet without passing through the bypass path.

4. The sound insulator according to claim 3, wherein
when a phase shift amount between the sound wave transmitted to the outlet through the bypass path and the sound wave transmitted to the outlet without passing through the bypass path is referred to as Δφ, the bypass path changes the phase of the sound wave that is passed through the bypass path so as to satisfy an equation 1 using an arbitrary coefficient N, which is an integer
+150+(N×360)≤Δφ≤+210+(N×360) Equation 1:

5. The sound insulator according to claim 4, wherein
the bypass path changes a phase of the sound wave that is passed through the bypass path so as to satisfy an equation 2 using an arbitrary coefficient N that is an integer
Δφ=±180+(N×360) Equation 2:

6. The sound insulator according to claim 2, wherein
when a direction that extends radially from an axis of the transmission space is defined as a radial direction, the inlet and the outlet have opening surfaces that intersect with the radial direction.

7. The sound insulator according to claim 2, wherein
the bypass path is formed inside the space forming portion.

8. The sound insulator according to claim 7, wherein
the space forming portion includes an inner cylindrical portion that extends along an axial direction, which is a direction in which a predetermined axis extends, and is formed in a hollow cylindrical shape to form the transmission space, and an outer cylindrical portion that extends along the axial direction, is disposed outside the inner cylindrical portion, and surrounds an outer periphery of the inner cylindrical portion,
the inner cylindrical portion has an inner outer peripheral surface facing the outer cylindrical portion, an inner inner peripheral surface surrounding the transmission space, and a plurality of through holes formed penetrating from the inner outer peripheral surface to the inner inner peripheral surface and provided at predetermined intervals in the axial direction,
the outer cylindrical portion has an outer inner peripheral surface facing the inner outer peripheral surface,
the bypass path is constituted by a bypass groove formed in a groove shape at a position facing the plurality of through holes on the outer inner peripheral surface,
the inlet and the outlet are any of the plurality of through holes,
at least one of the inner cylindrical portion and the outer cylindrical portion is rotatable in a circumferential direction around the axis, and
the bypass groove has a length that changes in accordance with a change in a relative position between the inner cylindrical portion and the outer cylindrical portion in the circumferential direction.

9. The sound insulator according to claim 8, wherein
the bypass groove has a one-side groove that transmits the sound waves transmitted from the inlet to the bypass groove to one side in the circumferential direction and guides them to the outlet, and an other-side groove that transmits the sound waves transmitted from the inlet to the bypass groove to the other side in the circumferential direction and guides them to the outlet.

10. The sound insulator according to claim 8, wherein
the inner cylindrical portion has a plurality of divided inner cylindrical portions arranged in the axial direction, each divided inner cylindrical portion having at least one through hole formed therein,
the divided inner cylindrical portions are rotatable in the circumferential direction independently of each other.

11. The sound insulator according to claim 7, wherein
the space forming portion has a first forming portion and a second forming portion each extending along an axial direction, which is a direction in which a predetermined axis extends, to form the transmission space,
the bypass path includes a first bypass pipe having a hollow shape provided in the first forming portion and a second bypass pipe having a hollow shape provided in the second forming portion,
the first bypass pipe has one side communicating with the inlet and the other side communicating with the second bypass pipe,
the second bypass pipe has one side communicating with the outlet and the other side communicating with the first bypass pipe,
at least one of the first forming portion and the second forming portion is movable in the axial direction, and
the first bypass pipe and the second bypass pipe are insertable into each other, and a bypass length changes as an insertion amount of the first bypass pipe and the second bypass pipe changes due to a change in a relative position of the first forming portion and the second forming portion in the axial direction.

12. The sound insulator according to claim 2, wherein
the bypass path is formed outside the space forming portion.

13. The sound insulator according to claim 12, wherein
a plurality of bypass paths are provided,
the space forming portion has a plurality of inlets and outlets each communicating with the plurality of bypass paths, and
the plurality of bypass paths have different bypass lengths.

14. The sound insulator according to claim 12, wherein
a plurality of bypass paths are provided,
the space forming portion has at least one of the inlet communicating with any one of the plurality of bypass paths, and at least one of the outlet communicating with any one of the plurality of bypass paths,
at least one of the plurality of bypass paths is in communication with one another, and
the inlets and the outlets are different in number from each other.

15. The sound insulator according to claim 14, wherein
the plurality of bypass paths have different bypass lengths.
